(19) United States
(12) Patent Application Publication
(10) Pub. No.: US 2016/0278368 A1
(43) Pub. Date: Sep. 29, 2016

(54) PLANT RHIZOSPHERE ENGINEERING RHIZO SIGNALING GEL MATRIX

(71) Applicant: AQUATROLS CORPORATION OF AMERICA, Paulsboro, NJ (US)

(72) Inventors: Andrea CARMINATI, GOETTINGEN (DE); Stanley J. KOSTKA, Cherry Hill, NJ (US); Mohsen ZAREBANADKOUKI, Goettingen (DE); Ahmed Mutez Ali ABDELRAHMAN, Goettingen (DE); Katayoun AHMADI, Goettingen (DE)

(21) Appl. No.: 15/080,745

(22) Filed: Mar. 25, 2016

Related U.S. Application Data
(60) Provisional application No. 62/138,866, filed on Mar. 26, 2015.

(51) Int. Cl. A01N 25/04; A01N 63/00

(52) U.S. Cl. CPC A01N 25/04; A01N 63/00

(57) ABSTRACT

A rhizo signaling gel matrix that alters a plant's water flow dynamics and increases plant drought tolerance is provided. The rhizo signaling gel matrix has mucigel, soil particles, and a rhizoligand. The rhizoligand is present at between about 1 μg/kg to about 1 g/kg. The rhizo signaling gel matrix forms an interconnected network of linkage between a plant's root and soil particles in the plant's rhizosphere.

### CROSS-REFERENCED APPLICATION

This application claims priority to U.S. Provisional Application No. 62/138,866, filed on Mar. 26, 2015, which is incorporated herein in its' entirety by reference thereto.

### BACKGROUND

1. Field of the Disclosure

The present disclosure relates to compositions and methods of making a rhizo signaling gel matrix that results in an engineered rhizosphere that alters a plant's water flow dynamics and increases plant drought tolerance. More particularly, the compositions and methods according to the present disclosure alter the rhizosphere rewetting and transpiration of plants.

2. Description of Related Art

Water scarcity is considered a major threat and challenge that must be overcome in the twenty-first century. Further, limited water supply is one of the largest impediments to crop production worldwide. For example, drought is a predominant cause of low crop yields. Increasing a plant's drought tolerance and improving the capacity of agricultural plants to extract water from soil are fundamentally imperative to sustaining a food supply that can meet the increasing food demand caused by modern population growth trends.

Soil drying and rewetting happen at various time intervals and with various degrees of volume or intensity. Wetting, as used herein, means providing water. Soil drying limits root water uptake and affects root synthesis of phytohormones and transport phenomena that regulate leaf growth and gas exchange. Consequently, without an abundant supply of water, crops suffer and yields are reduced.

Plants adapt to abiotic stress by undergoing diverse biochemical and physiological changes that involve hormone-dependent signaling pathways. One such hormone is Abscisic Acid (“ABA”). Exogenous ABA and its analogs have been used in foliar and soil directed spray applications to delay wilting and allow plants to survive short periods of severe drought as a means of maintaining marketability of horticulture and floriculture product and to extend shelf life. However, such sprays and topical applications of ABA do not alter the rhizosphere. The effect is limited over time and generally inconsistent and inefficient. Exogenous ABA has been shown to decrease yields of green and red lettuces. Concentrated exogenous abscisic acid drenches have been shown to reduce root hydraulic conductance and cause wilting in tomato. Other negative side effects include rate-dependent chlorosis of the lower leaves and leaf abscission.

In the face of growing populations and a shifting global climate, various production strategies have been developed to alleviate problems related to droughts and other shortages of water, but at the expense of crop yields. These strategies, which optimize the amount of crop production and water use, are crop specific and require exact knowledge of how a particular crop will respond. Further, these strategies may result in higher soil salinization which limits the effectiveness of such strategies and negatively impacts yield.

Attempts have also been made to use genetic modification to reduce water needs in plants and increase crop yields. However, there are countless concerns regarding genetically modifying crops, including unknown evolutionary consequences to crops and their ecosystem, safety for human consumption, and ethical concerns. Long term health effects in humans of consuming genetically modified crops are unknown.

There are important rhizosphere processes that regulate the availability of water to roots and other physiological and biochemical interactions that occur in the rhizosphere. There is a need to modify the ability of roots to extract water from the soil by managing the rhizosphere properties. Accordingly, there is a need for a system and method for targeted management of plant soil interactions, particularly modification of water dynamics in the rhizosphere and plant transpiration rates, that overcome these and other shortcomings.

### SUMMARY

The present disclosure provides a rhizo signaling gel matrix and method that modifies rhizosphere hydraulic properties, thereby providing faster and more uniform rewetting of the rhizosphere, increased initial water fluxes from the rhizosphere into the roots, reduced physiological recovery time of a plant after irrigation, and increased overall water availability to plants after irrigation.

The present disclosure provides a rhizo signaling gel matrix and method that engineers or modifies plant properties in the rhizosphere to reduce mucigel swelling and increase mucigel stability. A reduced swelling yields low saturated hydraulic conductivity. It is believed that a plant also senses a low level of water stress when the soil is wet.

The present disclosure provides a non-genetically modified organism approach to altering chemical and biological signaling in a plant. Such an approach increases plant water use efficiency and endogenous Abscisic Acid signaling efficiency. ABA is a plant hormone that functions in a plant's developmental processing. As an anti-transpirant, ABA induces stomatal closure, decreases transpiration to prevent water loss, inhibits fruit ripening, inhibits seed germination, regulates enzymes needed for photosynthesis, and prevents root growth when exposed to saline conditions.

The present disclosure provides a rhizo signaling gel matrix and method that increases a plant's tolerance to drought. This includes a reduction in transpiration when plants undergo repeated drying, wetting, and rewetting cycles. Further, the rhizo signaling gel matrix and method of the present disclosure induces a plant's stomates to partially close, thereby lowering transpiration rates while simultaneously increasing the duration of effective transpiration. Transpiration is unaffected when the soil remains wet; rather the drying/wetting cycle does not include a period of drought stress.

The presence of a rhizo signaling gel matrix according to the present disclosure in the rhizosphere increases a plant's water use efficiency.

The presence of a rhizo signaling gel matrix according to the present disclosure in the rhizosphere increases a plant's root biomass.

The presence of a rhizo signaling gel matrix in the rhizosphere according to the present disclosure increases a plant's root to shoot ration, thereby yielding a more robust plant.

The present disclosure provides a rhizo signaling gel matrix that acts as an interconnected networked linkage between a plant's roots and soil particles, thereby enabling a more efficient uptake of water and mineral nutrients by roots in dry soils.

The present disclosure further provides a rhizo signaling gel matrix and method that increases rhizosheath mass and extension. Thus, larger, enhanced, and more stable rhizosheaths are possible without the need for genetic modification.

The present disclosure provides a rhizo signaling gel matrix that can be used to control the water relations of root and mucigel in the rhizosphere. Rhizoligands increase the wetting kinetics of the rhizosphere, as well as the uniformity of the rhizosphere rewetting. This results in faster root rehydration upon irrigation as well as to a higher volume of water available to the plant. Remarkably, the higher water volume is also used more slowly, as the plant transpiration is suppressed. Rhizoligands also affect the swelling and viscosity of mucigel exuded by roots. By modifying the mucigel swelling, the hydraulic connectivity between soil and roots is controlled. Specifically, mucigel swelling decreases after drying and treatment with rhizoligands and therefore limits the diffusion of mucigel away from the roots. The suppressed mucigel swelling also results in decreased hydraulic conductivity of the rhizosphere, which induces moderate water stress, thereby reducing transpiration in plants that have undergone drying/wetting cycles, with important consequences like increased water use efficiency and increased root to shoot ratio, without genetic modification.

The faster rhizosphere rewetting in the samples irrigated with rhizo signaling gel matrix 10 results in a pulse of ABA from the roots to the shoot, which temporarily limits the opening of stomata and consequently limits transpiration.

### BRIEF DESCRIPTION OF THE DRAWINGS

The patent or application file contains at least one drawing executed in color. Copies of this patent or patent application publication with color drawing(s) will be provided by the Office upon request and payment of the necessary fee

FIG. 1 is an illustration of the agricultural rhizo signaling gel matrix according to the present disclosure.

FIG. 2 shows a system using the rhizo signaling gel matrix of FIG. 1.

FIG. 3 compares water flow through the soil with and without the rhizo signaling gel matrix of FIG. 1.

FIG. 4A compares irrigation flow in a rhizosphere with and without the rhizo signaling gel matrix of FIG. 1.

FIG. 4B compares the swelling of mucigel with and without the rhizo signaling gel matrix of FIG. 1.

FIG. 5 is a radiograph comparing wetting in a rhizosphere with and without the rhizo signaling gel matrix of FIG. 1.

FIG. 6 is a radiograph comparing wetting over time in a rhizosphere with and without the rhizo signaling gel matrix of FIG. 1 and shows the changes in water content over time

FIG. 7 shows test data comparing responses in root swelling for a rhizosphere with and without the rhizo signaling gel matrix of FIG. 1.

FIG. 8 is a radiograph comparing root swelling over time with and without the rhizo signaling gel matrix of FIG. 1.

FIG. 9 shows test data comparing water content over time for a rhizosphere with and without the rhizo signaling gel matrix of FIG. 1.

FIG. 10 is a photo comparing plants grown having a rhizosphere with and without the rhizo signaling gel matrix of FIG. 1.

FIG. 11A compares ABA concentration in the xylem of plants with and without the rhizo signaling gel matrix of FIG. 1, 2-5 hours after irrigation.

FIG. 11B compares concentration in the xylem of plants with and without the rhizo signaling gel matrix of FIG. 1, 19-25 hours after irrigation.

FIG. 12A shows test data comparing transpiration of lupines over time with and without the rhizo signaling gel matrix of FIG. 1.

FIG. 12B shows test data comparing transpiration of lupines by water content with and without the rhizo signaling gel matrix of FIG. 1.

FIG. 13 shows test data comparing water content over time for maize with and without the rhizo signaling gel matrix of FIG. 1.

FIG. 14 shows test data comparing transpiration over time for maize with and without the rhizo signaling gel matrix of FIG. 1.

FIG. 15 shows test data comparing dry matter, root shoot ratios, and green leaf area with and without the rhizo signaling gel matrix of FIG. 1.

FIG. 16 shows test data comparing water content over time of lupines with and without the rhizo signaling gel matrix of FIG. 1.

FIG. 17 shows test data comparing water content over time of lupines with and without the rhizo signaling gel matrix of FIG. 1, with the soil being kept moist.

FIG. 18 shows test data comparing mucilage water content with and without the rhizo signaling gel matrix of FIG. 1.

FIG. 19 shows test data comparing saturated hydraulic conductivity with and without the rhizo signaling gel matrix of FIG. 1.

FIG. 20 is a radiograph showing root swelling and water transport with and without the rhizo signaling gel matrix of FIG. 1.

FIG. 21 is a radiograph comparing water content and mucigel swelling 140 minutes after irrigation in a rhizosphere with and without the rhizo signaling gel matrix of FIG. 1, as illustrated in FIG. 4A and FIG. 4B.

FIG. 22 is a photo comparing a rhizosheath with and without the rhizo signaling gel matrix of FIG. 1.

FIG. 23 shows test data comparing enzyme activity in the bulk soil for a rhizosphere with and without the rhizo signaling gel matrix of FIG. 1.

FIG. 24 shows test data comparing enzyme activity in the rhizosphere for a rhizosphere with and without the rhizo signaling gel matrix of FIG. 1.

FIG. 25 shows test data comparing carbon concentrations in the rhizosphere and bulk soil for a rhizosphere with and without the rhizo signaling gel matrix of FIG. 1.

FIG. 26 demonstrates the comparative effect of two rhizoligand according to the rhizo signaling gel matrix of FIG. 1 and water.

### DETAILED DESCRIPTION OF THE PREFERRED EMBODIMENTS

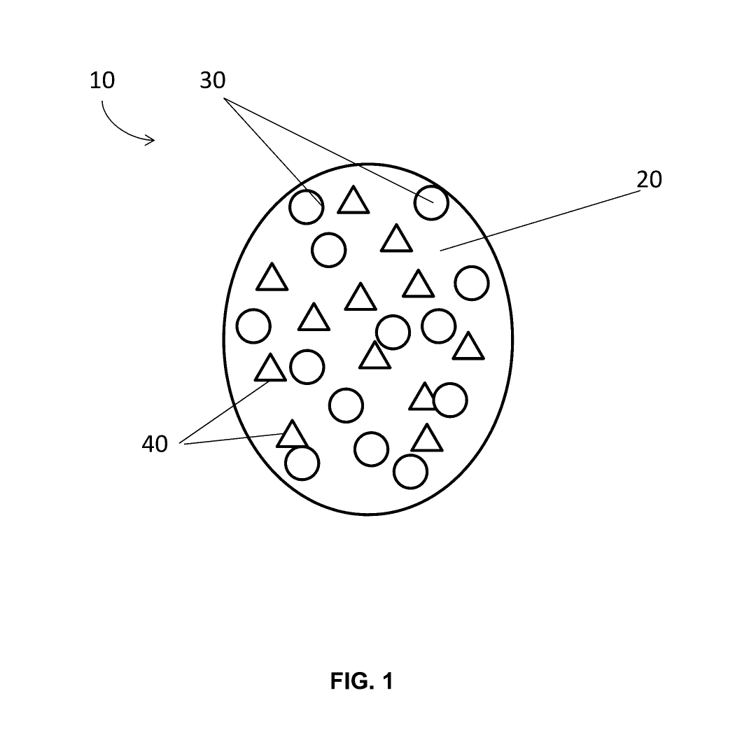

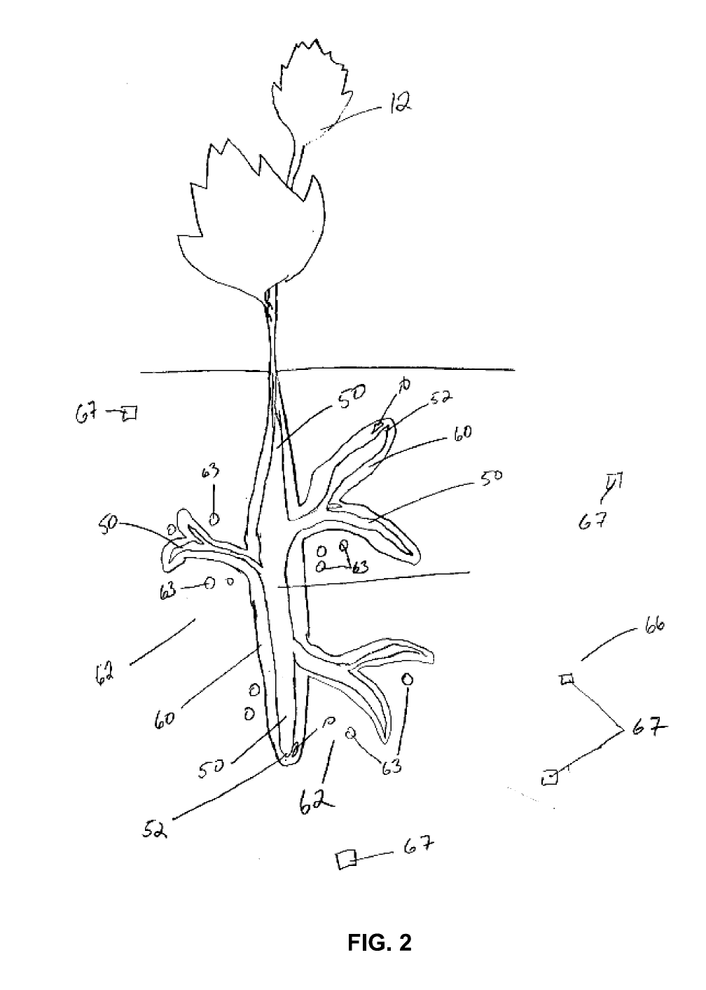

Referring now to the drawings and, in particular, FIGS. 1 and 2, there is shown a rhizo signaling gel matrix generally represented by reference numeral 10. Rhizo signaling gel matrix 10 comprises a mucigel 20, soil particles 30, and a rhizoligand 40. Rhizo signaling gel matrix 10 acts on roots 50 of plant 12 in the plant's rhizosphere 60.

Rhizosphere 60 is a thin layer of soil adjacent to a root, directly influenced by root exudation, and whose physical, chemical and biological properties are different from those of bulk soil. The rhizosphere begins at the root surface and extends into the soil over a distance of up to about 30 mm, preferably up to about 5 mm, and most preferably about 1 mm, and any subranges therebetween.

Rhizoligand 40 is a compound that complexes plant and microbial exudates (polysaccharides with lipophilic components) stabilizing them to the form a rhizo signaling gel matrix. Rhizoligand 40 also indirectly affects the duration and longevity of mucigel.

The rhizo signaling gel matrix is a complex net of soil particles, root and microbial exudates including mucigel, dead root cells and fungal hyphae bound together by the rhizoligand.

Mucigel 20 is a slimy substance that covers a rootcap 52 of the roots 50 of a plant 12. It is known to be a highly hydrated polysaccharide. Mucigel 20 is secreted from the epidermal cells of rootcap 52. Formation occurs in the Golgi bodies. Secretion is known as exocytosis. Mucigel is excreted from a plant root, but mucigel and mucigel-like derivatives can also be synthesized and/or formulated.

Mucigel 20 has numerous functions, including protecting the rootcap 52 and preventing desiccation, lubricating the rootcap 52 to allow the root to efficiently and effectively penetrate the soil, and creating symbiotic environments for soil microorganisms.

Again, the layer of microorganism-rich soil immediately surrounding the mucigel and that is impregnated with the mucigel is rhizosphere 60. Distinguishable therefrom and adjacent rhizosphere 60 is root zone 62. As water is absorbed, rhizosphere 60 expands, and as the plant transpires, rhizosphere 60 contracts. Root zone 62 contains root zone soil 63, which is the volume of soil that is penetrated by plant roots 50 during growth. Root zone 62 is not part of rhizosphere 60, but rather, lies just outside the rhizosphere. Beyond root zone 62, is a third zone 66 containing bulk soil 67. Bulk soil refers to soil that is not penetrated by plant roots 50 and that is not modified by the roots.

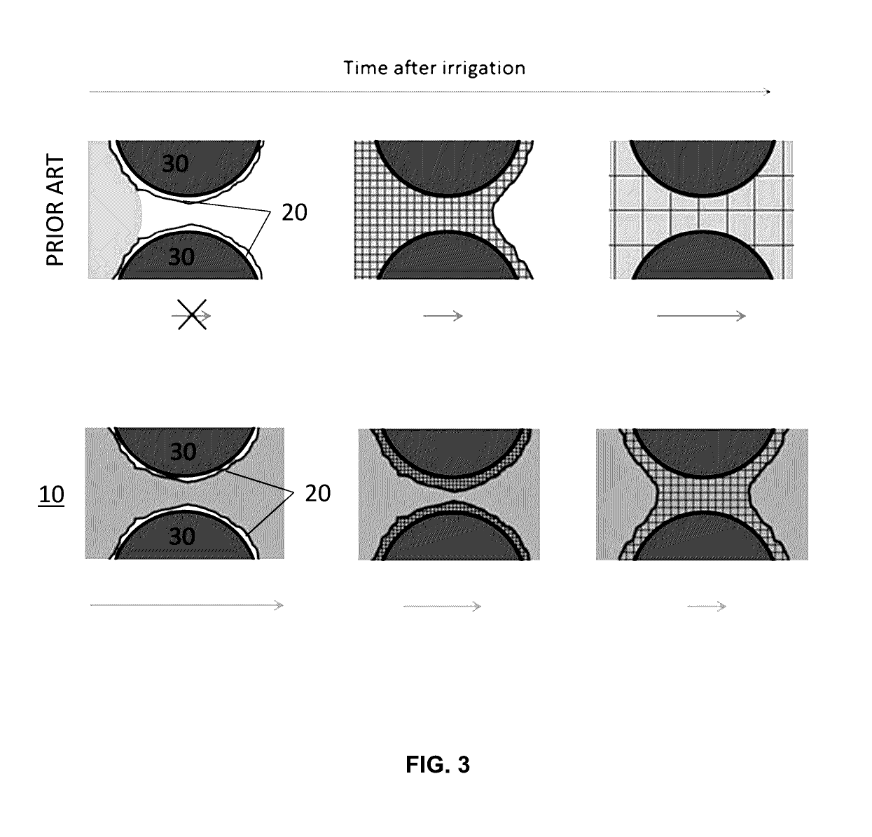

FIG. 3 is a conceptual model illustrating the function and infiltration of plants irrigated with water (top row) compared to plants having rhizo signaling gel matrix 10 that includes a rhizoligand (bottom row).

In the top row, there are shown two soil particles 30 near a normal root (not shown) being irrigated with water 14 in an unmodified environment. The pore space between two soil particles 30 covered with dry mucigel 20 is illustrated during rewetting. Dry mucigel 20 is hydrophobic and temporarily limits the soil rewetting shown at t₁. As mucigel 20 starts to adsorb water, soil 50 rewets at t₂. The soil's hydraulic conductivity increases as the mucigel hydrates at t₃. Notably, there is large expansion of rhizosphere.

In contrast to the unmodified environment, a modified rhizosphere with rhizo signaling gel matrix 10 is shown in the bottom row. There is a reduction of the contact angle and quicker rewetting of the soil at t₁. As mucigel 20 swells, at t₂, the soil hydraulic conductivity decreases. Rhizoligand 40 acts to decrease mucigel 20 swelling. Mucigel 20 does not fully expand resulting in a reduced soil hydraulic conductivity at t₃. Stated another way, the rhizoligand 40 in rhizo signaling 10 creates an interconnected linkage between plants roots and soil particles.

Without wishing to be bound by a particular theory, it is believed that rhizo signaling gel matrix 10 causes recognition phenomenon in a plant to occur or causes a change in water gradient which triggers production of ABA, influences microbial populations, and plant biochemical responses.

Root water uptake generates a gradient in soil water potential and soil water content toward the roots. The gradients become steeper when the soil dries. When the water potential at the root surface decreases below a critical value, such as −1.5 MPa, roots send a signal to the leaves to close the stomata or ABA production is increased, travels by transpiration to the stomata, to signal the closing thereof. The lower hydraulic conductivity from rhizo signaling gel matrix 10 may signal inducing enhanced ABA production, stomatal closure and transpiration reduction. At this point both transpiration and photosynthesis decrease.

Rhizo signaling gel matrix 10 unexpectedly alters the water dynamics in rhizosphere 60 and creates interconnected linkages between the soil particles and an interface between the rhizosphere and plant root to increase biological and chemical communications. During drying rhizosphere 60 is wetter than bulk soil 67 and soil in root zone 62. Because of rhizo signaling gel matrix 10, the hydraulic connection between rhizosphere soil and roots is maintained. The region around the roots becomes hydrated and conductive. Root hydration is defined as root swelling. Contact between roots and soil, necessary for nutrient uptake, is maintained. High levels of microbial activity result thereafter. Moreover, a region for active communication between plants and the rhizomicrobiome, i.e., the root associated microbes, is established.

Without rhizo signaling gel matrix 10, after drying, the rhizosphere becomes water repellent (at most 25% moisture, preferably between about 5 and 20%, most preferable between 10 and 20%). Upon wetting or after irrigation, the bulk soil is wettable, but the rhizosphere is not. water depletion around the root occurs. Root water uptake cannot be sustained by the soil alone. The result is soil hydraulic failure, and as such, the plant dehydrates. As a plant dehydrates, roots shrink and lose contact with the soil. A gap results. There is additional resistance. Stated another way, continuity between the water and the root surface is interrupted without rhizo signaling gel matrix 10.

Without rhizo signaling gel matrix 10, mucilage expands, becomes less viscous, and it diffuses into the bulk soil. As it dries, it becomes hydrophobic.

Rhizo signaling gel matrix 10 and in particular, rhizoligand 60, instead result in a more viscous and more hydrated rhizosphere 60, with less swelling and less diffusive mucilage. Rhizosphere 60 stays closely appressed to the root, i.e., without a gap. Also, rhizosphere 60 quickly rewets after being treated with the rhizoligand. A continuous interface between the rhizosphere and a plant root is maintained, even as the plant root dries and shrinks, because rhizoligand maintains the rhizosphere appressed to the root.

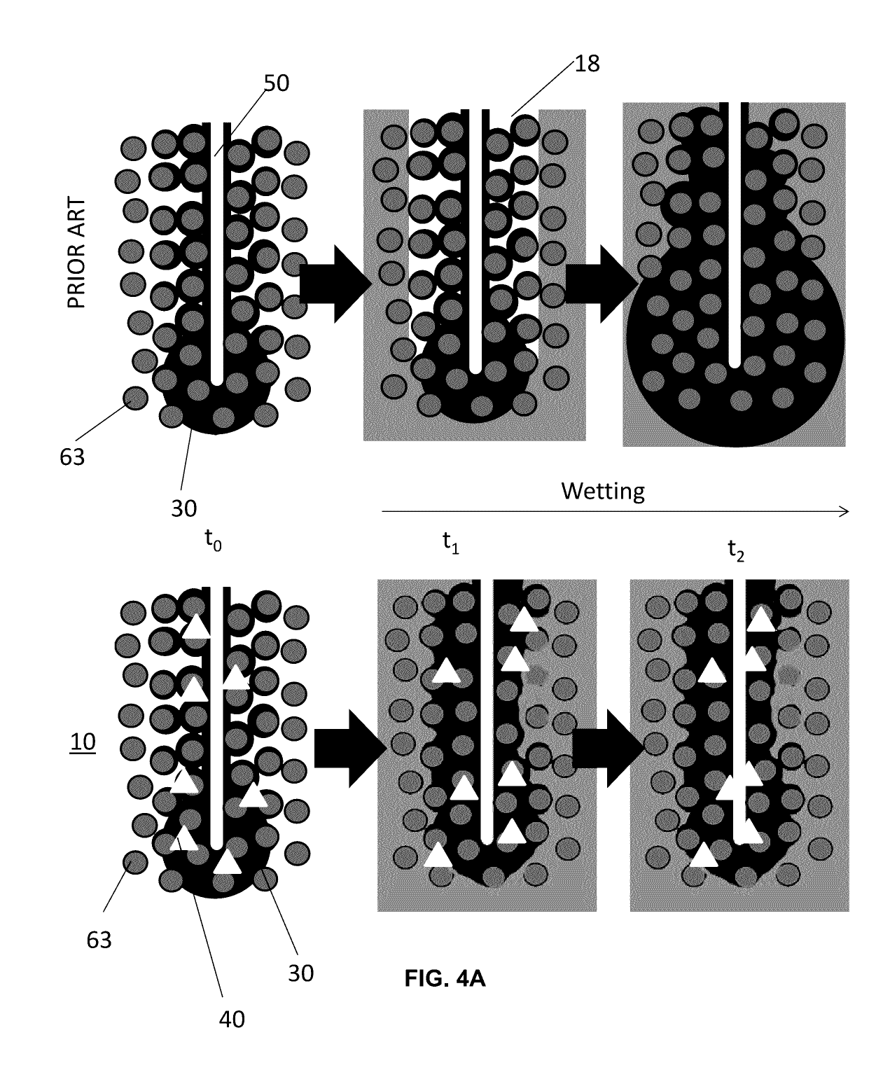

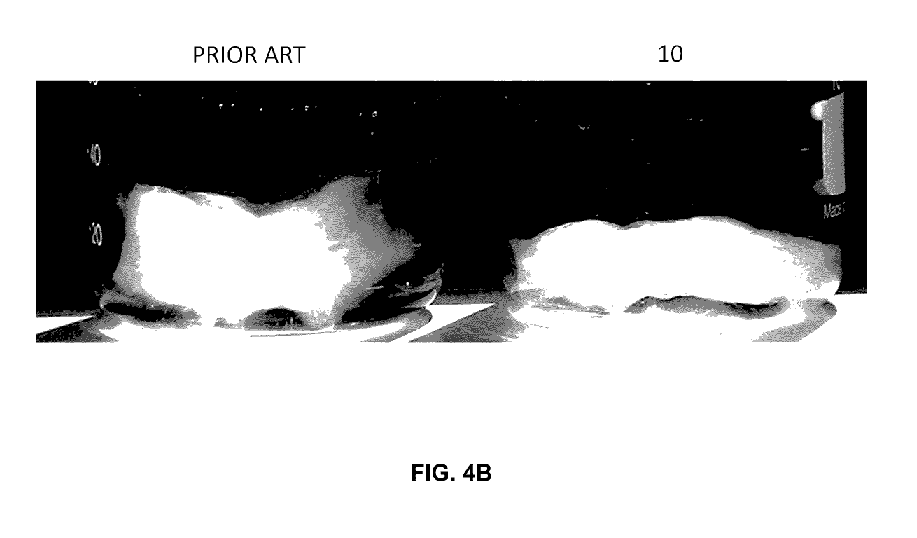

FIG. 4A, on the bottom row, shows a root 50 enveloped by mucigel 20, rhizoligand 40, with soil 30 in the rhizosphere and soil 63 in the root zone. As time moves forward wetting is immediate, and rhizo signaling gel matrix 10 adsorbs water readily. As shown at t₂, there is limited swelling due to the interconnected linkage formed between the root and soil particles. In contrast, as shown in the top row, where rhizo signaling gel matrix 10 is not present, drying 18 occurs in the rhizosphere. Further and upon full wetting, the rhizosphere adsorbs water and expands significantly.

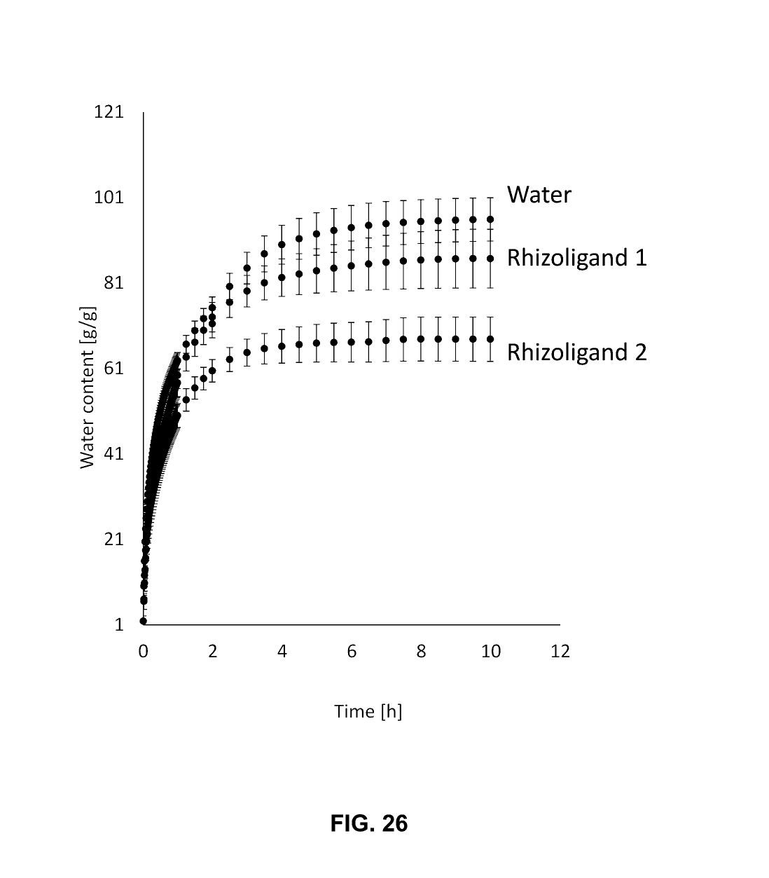

FIG. 4B shows that mucilage 20 having rhizoligand 40 increases in density, maintains position, and prevents diffusion compared to water, which results in swelling. FIG. 26 demonstrates the comparative effect of two different rhizoligands 40 compared to water.

The interconnected linkages created within rhizo signaling gel matrix 10, as described above, produce a physiological response in the plant such that the plant responds as if under a water deficit. The linkage creates an interface for nutrient uptake, improves cationic exchange capacity, and stimulates production of ABA that is transported to the shoot.

The increase in water flux into the roots is a short term pulse. Even though the rhizo signaling gel matrix is less conducive to flow, it leads to a seven times faster pulse of water to the shoot, after irrigation The faster pulse is explained by the faster rehydration of the rhizo signaling gel matrix. Because of rhizo signaling gel matrix 10, rewetting the rhizo signaling gel matrix results in the flow of water across the root-soil interface and to the shoot during the first 1-2 hours after irrigation, enhancing the transport of ABA to the shoot, i.e., an ABA pulse after irrigation.

Transpiration and stomatal conductance are controlled by root-shoot signaling and by the hormone ABA. High ABA concentration in the xylem results in transpiration reduction. ABA is a phyto-hormone regulating stomatal opening/closing, thereby affecting transpiration. It is also involved in drought and salinity tolerance

Plants treated with rhizoligands transpire less than not treated plants. It is well accepted that higher ABA concentration impacts guard-cells of stomates, resulting in partial, if not full, stomatal closure. In this case, stomatal closure is better regulated (partial closure). The reduced transpiration occurs during dry-down periods between irrigation. Some degree of water stresses are needed to reduce transpiration and induce ABA production. A drying cycle initiates the effect.

Rhizoligands, such as certain surfactants, reduce mucigel swelling and increase its viscosity. The rhizoligand prevents mucigel expanding or diffusing away from the root surface or outside the rhizosphere, and maintains a higher concentration of mucigel near the root surface. This has additional positive implications for the activity of microorganisms in the rhizosphere and results in a more effective symbiotic relationship between rhizosphere microorganisms and plants. Because there is lower mucigel swelling, there is also a low saturated hydraulic conductivity of the rhizosphere.

The presence of rhizo signaling gel matrix 10 reduces rhizosphere conductivity. The plant senses a low level water stress, even when the soil is wet. This leads to a partial closure of the stomata and to a moderate suppression of transpiration. The lower transpiration results in a saving water strategy. Plants consume a given amount of water in longer time. Low or reduced irrigation frequency techniques can be applied without a loss of yield. Consequent to the partial closure of the stomata, plant water use efficiency is also increased. Further, the root/shoot ratio is increased, which means more robust and drought tolerant plants.

In some embodiments, suitable rhizoligands in accordance with the present disclosure include alkyl terminated block copolymers, alkylpolyglycoside, ethylene oxide, propylene oxide, polymers based on ethylene oxide, polymers based on propylene oxide, ethylene oxide/propylene oxide block copolymers, and combinations thereof. Suitable rhizoligands can be mixtures of compounds with different sugars comprising the hydrophilic end and alkyl groups of variable length comprising the hydrophobic end. Rhizoligands can also include ethoxylated aliphatic alcohol, carboxylic esters, polyethylene glycol esters, anhydrosorbitol ester and ethoxylated derivatives thereof, glycol esters of fatty acids, carboxylic amides, monoalkanolamine condensates, polyoxyethylene fatty acid amides, and combinations thereof.

The most preferred rhizoligands are ethylene oxide/propylene oxide block copolymers and alkyl terminated block copolymers.

In certain embodiments, rhizoligands have a hydrophilic/lipophilic balance (HLB) between about 4 to about 30, more preferably between about 6 to about 14, and most preferably between about 7 to about 9, and any subranges therebetween.

In preferred embodiments, rhizoligands are biologically compatible for food and/or have a low level of toxicity.

Rhizoligands in accordance with the present disclosure are present in rhizo signaling gel matrix 10, preferably at a concentration of about 1 μg/kg to about 10 g/kg, more preferably about 5 mg/kg to about 1 g/kg, and most preferably about 10 mg/kg to about 100 mg/kg, and any subranges therebetween.

Suitable rhizoligands have one or more of the following properties: contact angle in the rhizosphere, rewetting rate of the rhizosphere, limited swelling after mixing with mucigel, higher viscosity after mixing with mucigel, and water retention after mixing with mucigel.

By way of non-limiting example, the contact angle in the rhizosphere can be about 0° to about 120°, preferably about 0° to about 60°, with 0° to about 30° being most preferred, and any subranges therebetween.

By way of non-limiting example, the rhizosphere rewetting rate can be between about 1 minute to about 2 days, preferably between about 1 minute to about 60 minutes, with between about 1 minute to about 10 minutes being most preferred, and any subranges therebetween.

By way of non-limiting example, the maximum swelling of the rhizoligand mixed with mucigel can be between about 0 to about 1000 gram of wet gel per gram of dry gel, preferably about 100 to about 500 gram of wet gel per gram of dry gel, with between about 200 to about 300 gram of wet gel per gram of dry gel being most preferred, and any subranges therebetween.

Soil 30 can be wettable soil or non-wettable soil. A wettable soil is a soil that has the ability to intake water. A non-wettable soil is a water repellent soil that has waxy, hydrophobic organic compounds coating soil particles. Consequently, a non-wettable soil repels water. Water repellence is mostly associated with sandy-textured soils, but can affect some heavier textured soils (for example forest loamy gravels).

Water availability to plant roots is controlled by the hydraulic properties of the rhizosphere. As discussed above, rhizosphere is the thin layer of soil in intimate vicinity of the roots. Importantly, hydraulic properties of the rhizosphere differ from those of the bulk soil and root zone soil. The rhizosphere remains wetter than the bulk soil during drying. The rhizosphere remains markedly dry after irrigation and it can be rewetted in only a few days. Thus, water content is higher in the rhizosphere during drying and the rhizosphere has temporarily lower water content after irrigation. Mucigel is a hydrogel exuded by most of plants. Mucigel has a large affinity to water and at saturation it has water content up to about 500 times its dry weight or more. The rhizo signaling gel matrix is primarily polysaccharides and some lipids that make it hydrophobic upon drying.

It has been found by the present disclosure that rhizoligands modify the water dynamics in the rhizosphere and transpiration rates, among other functions. ACA3282 and ACA3276 (Aquatrols® Corp., Paulsboro, N.J., U.S.A.) were used as rhizoligands during experimentation. ACA3282 and ACA3276 are surfactants that are exemplary of suitable rhizoligands according to the present disclosure. ACA3282 and ACA3276 are rhizoligand 1 and rhizoligand 2, respectively

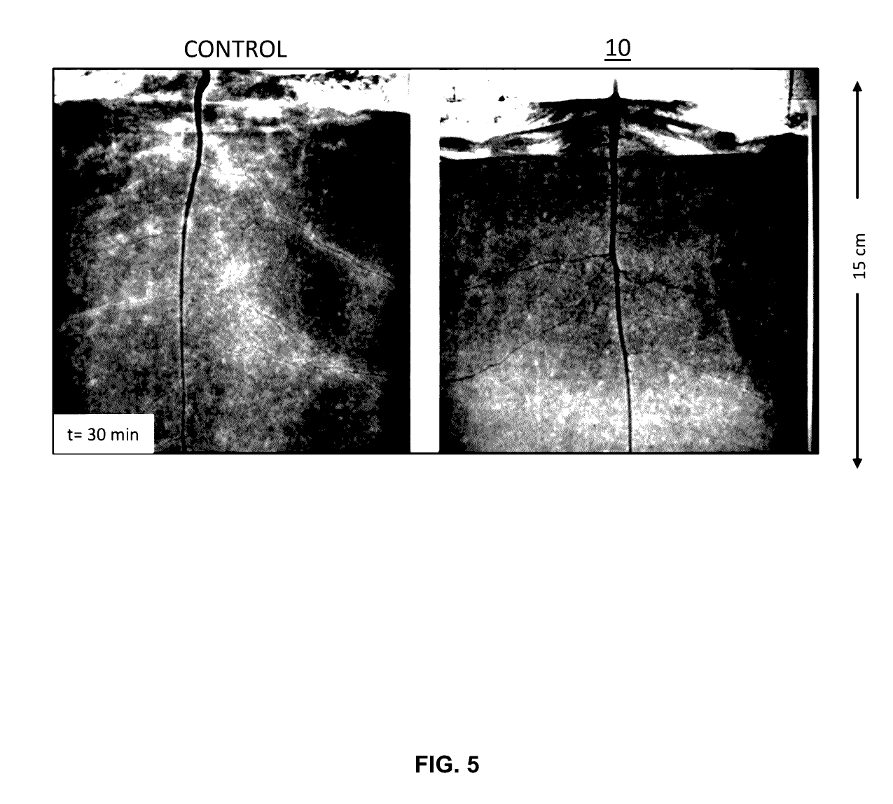

With rhizo signaling gel matrix 10, the rhizosphere is rewetted more quickly and more uniformly than with normal water. FIG. 5 shows a neutron radiograph of 3 week old lupines in sandy soil 30 minutes after irrigation. Darker shades indicate high water contents while lighters shades indicate low water contents. The control sample with normal water irrigation remained relatively dry, whereas the sample with rhizo signaling gel matrix 10 rewetted immediately after irrigation. In the images, the water content is proportional to the gray values: i.e. darker means wet. The control sample shows that the rhizosphere of most of the roots appears brighter than the bulk soil. This shows that the rhizosphere remained dry. On the contrary, in the sample having rhizo signaling gel matrix 10 that was irrigated with ACA3282 concentration of 0.1 g/L (gram of ACA3282 per liter of water), the rhizosphere appears as dark as the bulk soil. This shows that the rhizosphere was quickly rewetted. Rhizo signaling gel matrix 10 facilitates the wetting rate of the rhizosphere. The rhizosphere of the control rewetted only after 1-2 hours. Instead, the rhizosphere having rhizo signaling gel matrix 10 was rewetted within a few minutes. The experiment was replicated 5 times. 5 samples were the control and 5 had rhizo signaling gel matrix 10 with ACA3282 as the rhizoligand. Each replication showed the same behavior.

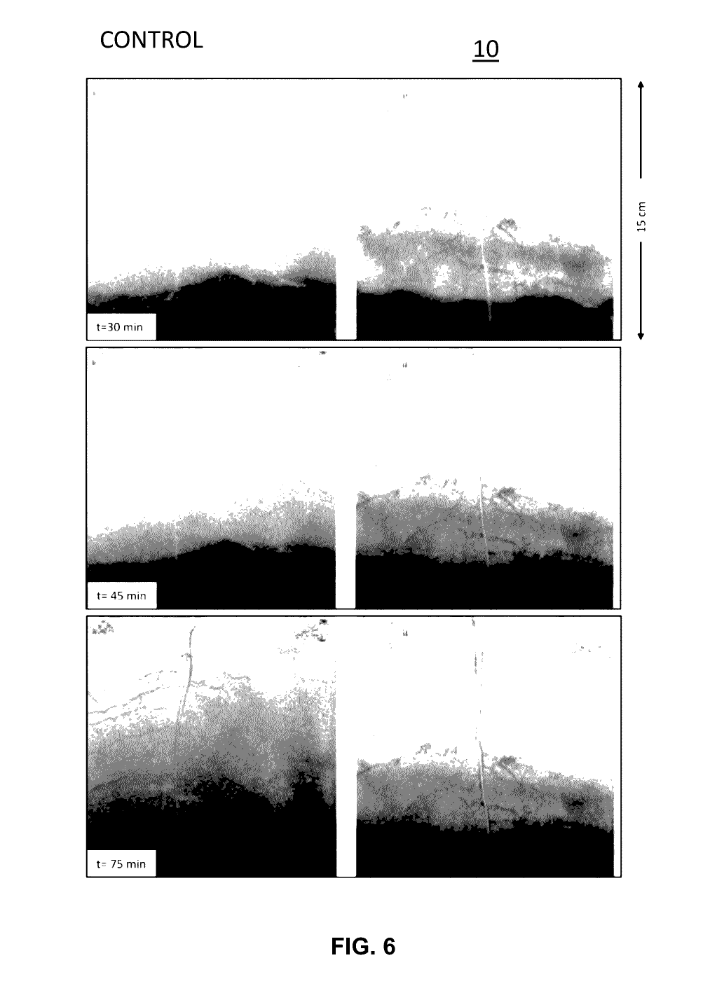

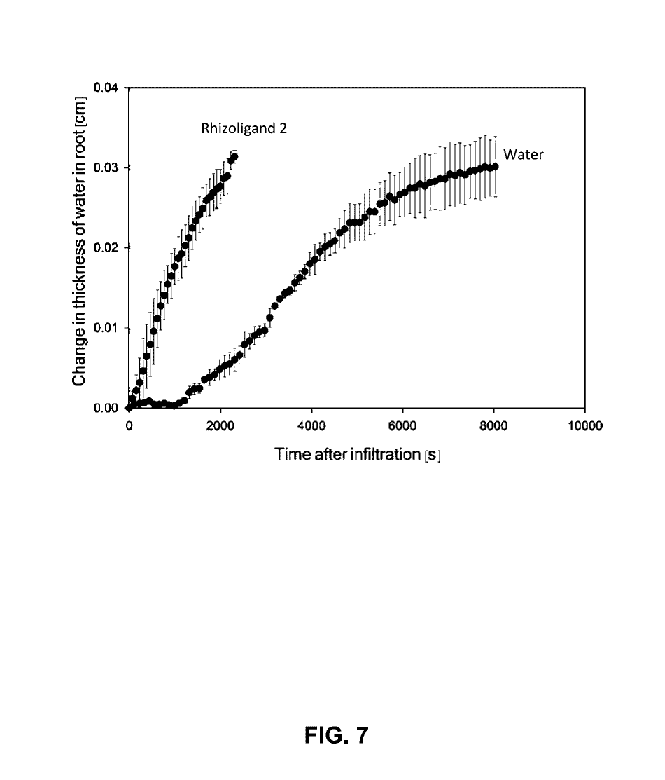

Referring now to FIGS. 6 and 7, experiments were also conducted to show that rhizo signaling gel matrix 10 facilitates plant rehydration. Again, ACA3282 was used as the rhizoligand. Results indicated the rehydration of the root tissue was faster with rhizo signaling gel matrix 10.

In FIG. 6 changes in water content over time are shown. The samples are the same shown in FIG. 5. The difference refers to a radiograph taken when the irrigation front almost reached the bottom of the field of view (t=30 minutes). In FIG. 6, bright gray colors indicate no change in water content; dark gray colors indicate increase in water content. In the sample with rhizo signaling gel matrix 10, the roots and part of the rhizosphere turned black, indicating an increase in water content. This was slower and much less pronounced in the control samples.

To quantify the root swelling, the focus was on the upper part of the tap root. The tap root shrinks up to 25% during severe drying, corresponding to a decrease in diameter of 0.3 mm. The swelling of the upper part of the tap root was used as a proxy for the root tissue rehydration. The changes in the diameter of the taproot are calculated from the neutron radiographs according to the following method: the intensity of the neutron beam transmitted behind the sample depends on the thickness and composition of the sample. More specifically, in each pixel of the image the logarithm of the ration between the transmitted and incident beam, divided the neutron attenuation coefficient of water, gives the thickness of water in each point of the sample. The resulting changes in root diameter are plotted in FIG. 7. FIG. 7 shows that the taproot of plants having rhizo signaling gel matrix 10 swelled faster than those of plants irrigated with water. This indicates that rhizo signaling gel matrix 10 favors water flow to roots after drying and subsequent irrigation.

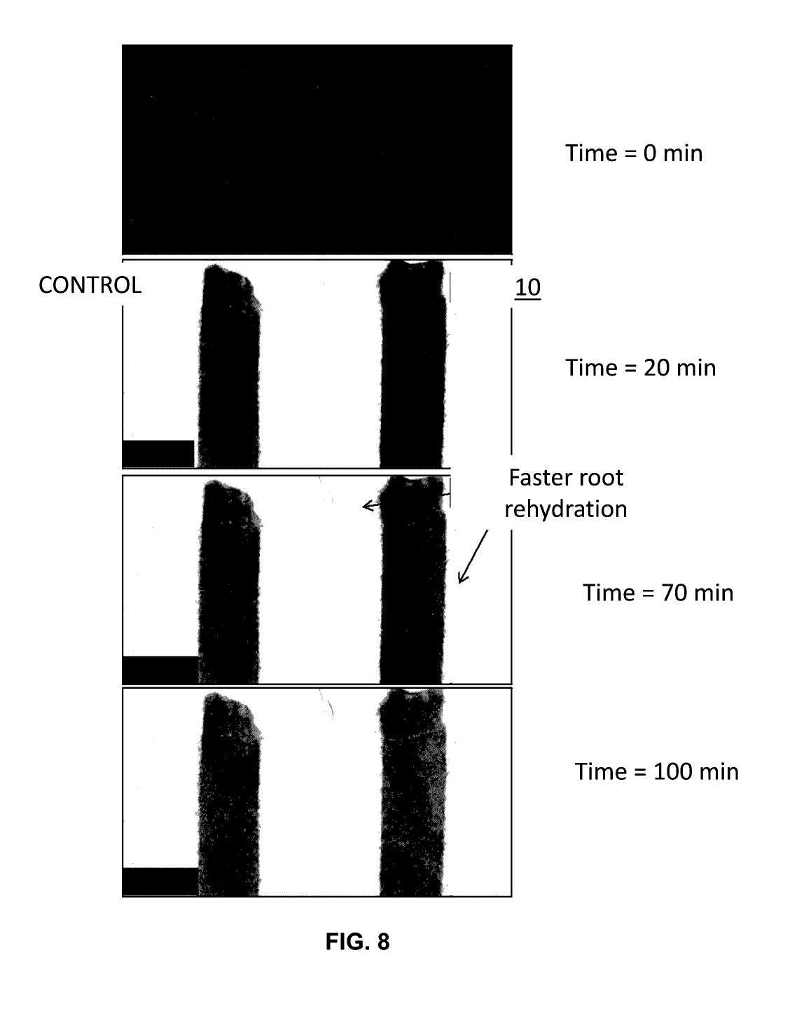

One of the challenges in estimating the root swelling from FIG. 6 was to correctly distinguish between root swelling and rhizosphere wetting. The segmentation of the root system will affect the estimation of root swelling in FIG. 6. To avoid this problem, experiments were performed with larger samples (30×30×1 cm) where control samples and samples with rhizo signaling gel matrix 10 were applied in confined soil regions. Lupines were grown for 30 days, were allowed to dry and then watered simultaneously. A time series radiograph of the upper part of the sample during irrigation is shown in FIG. 8. Radiographs were taken at 0, 20, 70, and 100 minutes. FIG. 8 shows the difference between the actual image and the image before irrigation. An increase in water content appears in black. The time series shows that the roots that were locally irrigated with rhizo signaling gel matrix 10 rehydrated faster than the control. This experiment was repeated four times and showed that rhizo signaling gel matrix 10 increases the water flow into the roots after irrigation, and therefore facilitates and hastens plant recovery upon irrigation.

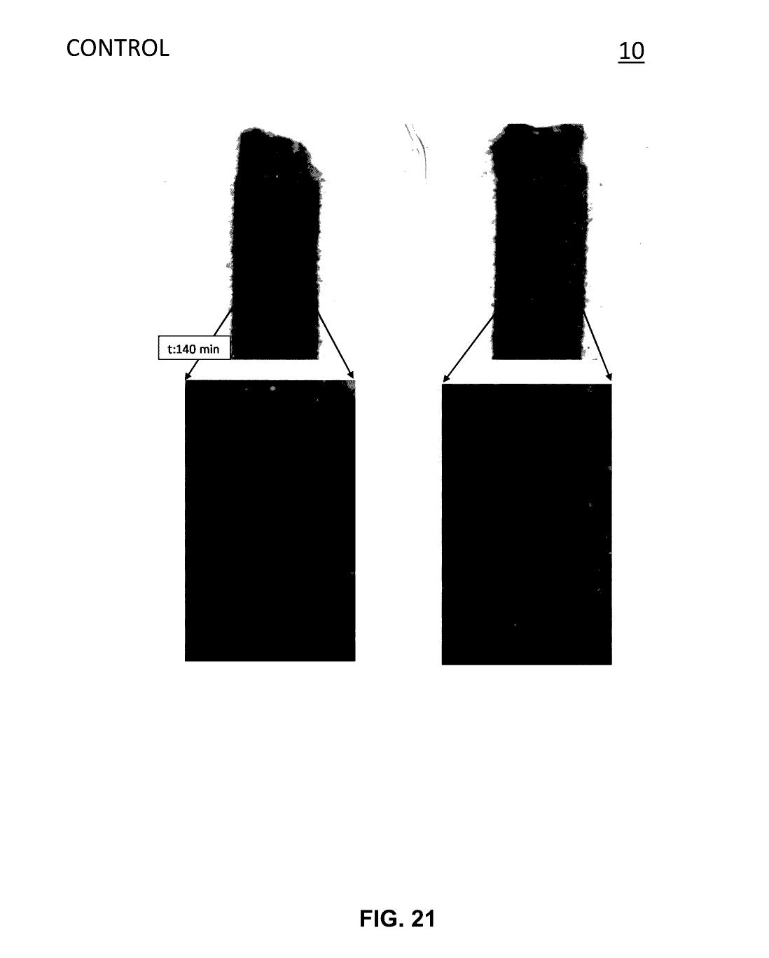

FIG. 21 is a magnification of the radiograph taken 140 minutes after irrigation. FIG. 21 shows that the rhizosphere containing rhizo signaling gel matrix 10 did not rehydrate as much as the control samples. This was caused by the rhizoligands that did not allow mucilage to swell as much as in the control sample. This figure demonstrates the concepts shown in FIGS. 3 and 4.

Further experiments were conducted to demonstrate the effect of rhizo signaling gel matrix 10 on soil water availability. In this experiment, ACA3282 and ACA3276 were used as rhizoligands for root water uptake of lupine and maize during repeated drying/wetting cycles. Ten lupines were planted in containers of 12×12×1 cm filled with sandy soil. The samples were grown in a climate chamber with day/night temperature of 24/19° C., humidity 60%, photoperiod of 14 hours. The plants were kept irrigated by capillary rise from the bottom (1 cm water table) for two weeks. After two weeks the water at the bottom of the sample was removed and the samples were allowed to dry. When the plants showed wilting symptoms, the samples were irrigated again by immersing the samples in 1 cm water table for one hour. Half of the samples were used as a control. Then, the water at the bottom was removed and another drying cycle was repeated. In total, there were 6 drying cycles. During the drying/cycles we measured transpiration rate by weighing the samples at regular intervals.

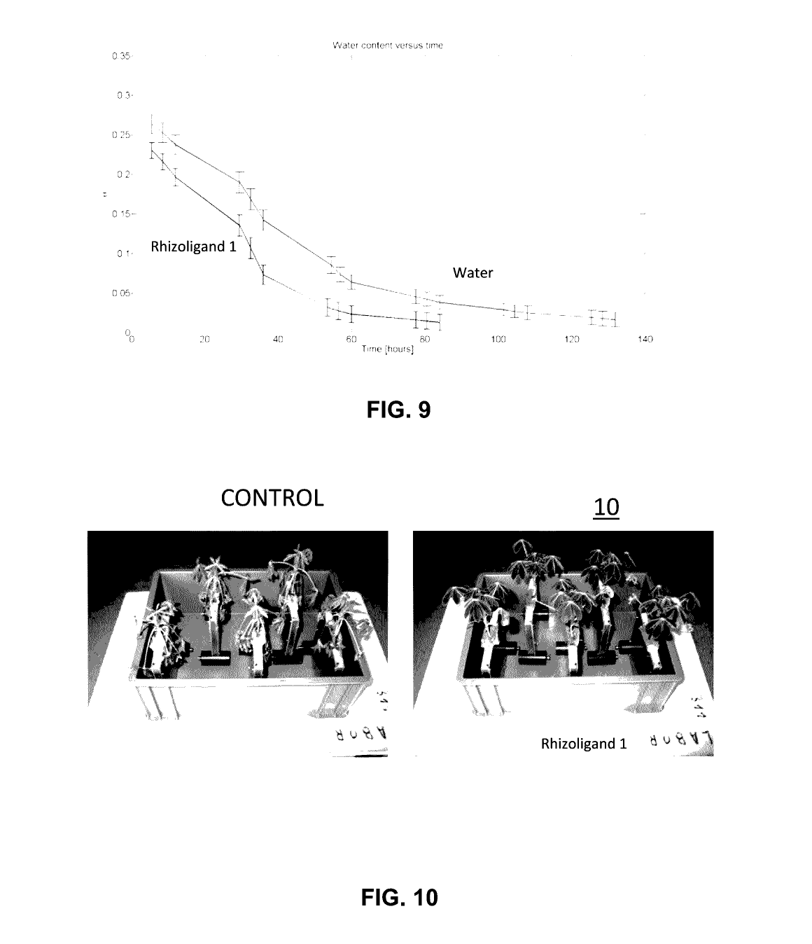

FIG. 9 shows the soil water content, θ or the volume of water divided by the total volume, during the last drying period. FIG. 9 shows the water content after irrigation and during one drying period until the plants showed wilting symptoms. In addition, the plant having rhizo signaling gel matrix 10 started with higher water content. This is believed to be the result of rhizo signaling gel matrix 10 having a high rewettability in the rhizosphere, compared to the control samples where the rhizosphere remained dry. This was also discussed and demonstrated above.

An image of the plants at day 4 is shown in FIG. 10. FIG. 10 shows that plants in the control sample, irrigated with water, wilted, while the plants having rhizo signaling gel matrix 10 were still well turgid, and remained so for 2 additional days.

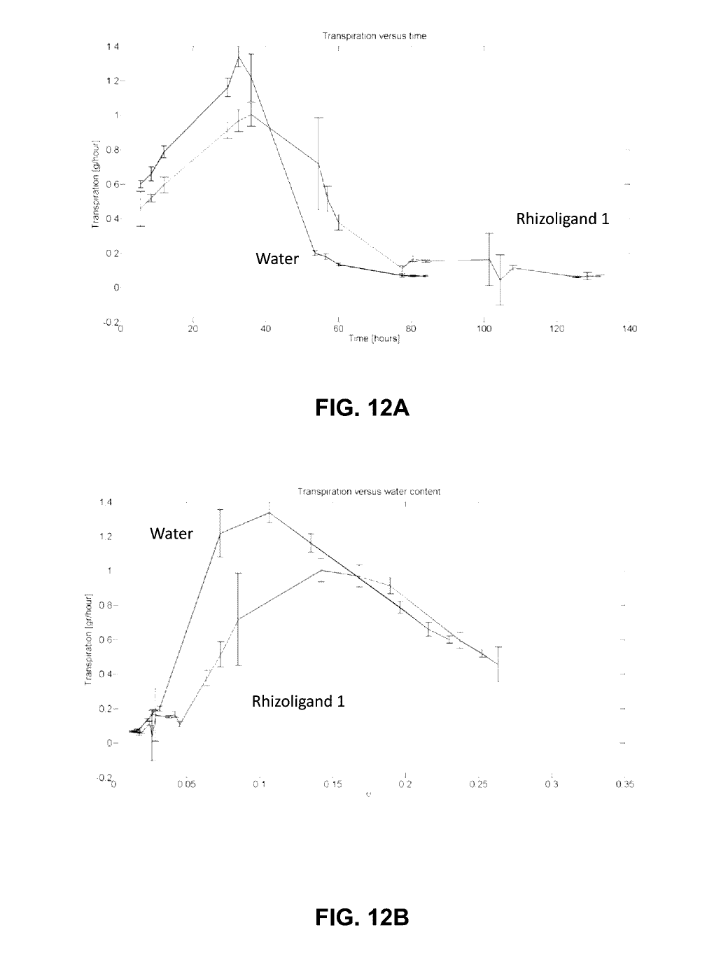

Transpiration was measured gravimetrically. Transpiration rates over time are plotted in FIG. 12A. The first points correspond to four hours after irrigation. FIG. 12A shows that in both the control sample and sample with rhizo signaling gel matrix 10, transpiration rate increased for 1-2 days after irrigation. During this phase, the transpiration rate in the control sample was higher than in the sample with rhizo signaling gel matrix 10. Around 40 hours after irrigation transpiration rate started to decrease because of the reduction in soil water content. This is better shown in FIG. 12B, where transpiration rates are plotted as a function of the water content.

FIG. 12B shows that during the initial phase, when the water content was relatively high, transpiration increased with decreasing water content. This was simply explained by the reopening of stomata after drying. FIG. 12B shows that when the soil became dry, transpiration started to decrease. The water content at which transpiration started to decrease was different in control sample and sample with rhizo signaling gel matrix 10. In the control sample, transpiration decreased at a water content of approximately 0.1. Instead, in the samples with rhizo signaling gel matrix 10, transpiration started to decrease at a water content of approximately 0.15. At a water content of 0.07, transpiration rate in the samples with rhizo signaling gel matrix 10 is half of the transpiration of the control samples. The samples with rhizo signaling gel matrix 10 reach the lower transpiration rate at a water content of 0.05 and remain turgid until reaching a water content of 0.02-0.03. The low transpiration during the first two days and the higher initial water contents are believed to be reason why the plants with rhizo signaling gel matrix 10 wilted later.

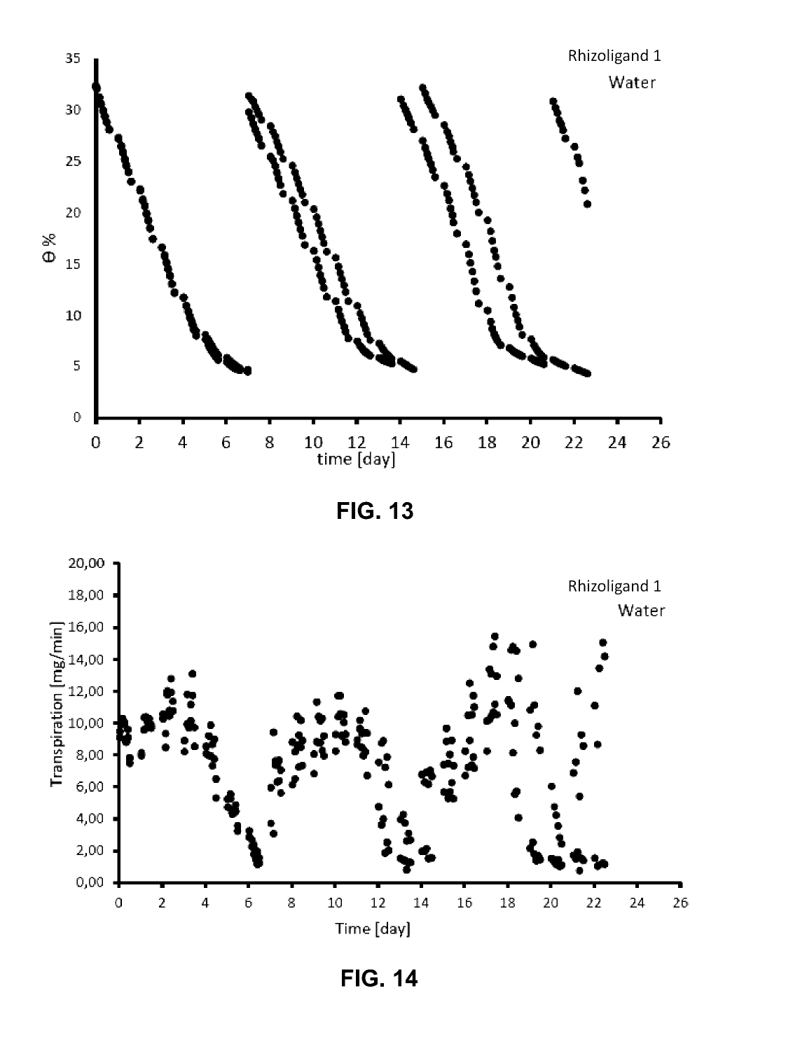

The experiments were repeated with maize instead of lupine. The transpiration curves were similar to those of lupines. Transpiration rates were also reduced in maize having rhizo signaling gel matrix 10 after repeated drying/wetting cycles. The results are shown in FIGS. 13 and 14. FIG. 13 shows average water content in the maize during three drying and wetting cycles between the control sample and sample with rhizo signaling gel matrix 10. Time zero refers to the initial wetting. FIG. 14 shows the transpiration rate calculated gravimetrically during the drying phases.

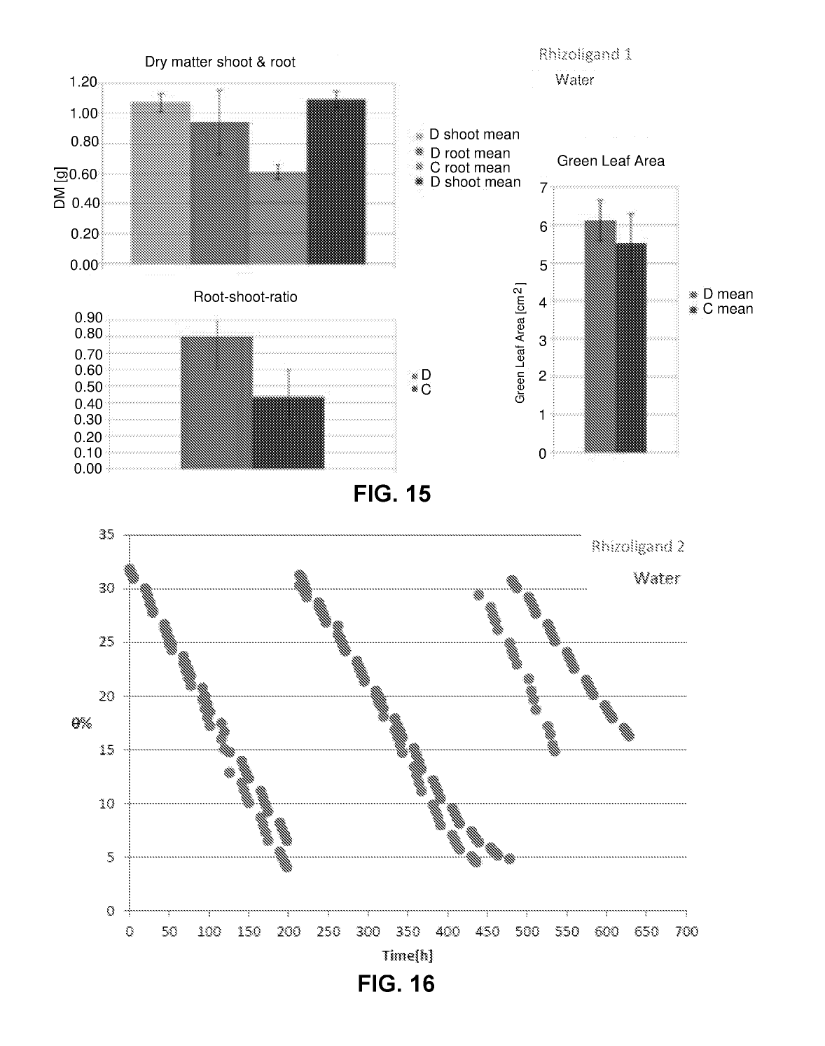

Additional experiments were conducted to measure root and shoot biomass. Again, control samples having only water and tests samples having ACA3282 as the rhizoligand of rhizo signaling gel matrix 10 were used. Plants with rhizo signaling gel matrix 10 had a higher biomass and significantly higher root/shoot ratio compared to the control samples. The results are shown in FIG. 15. The root/shoot ratio increases by at least 1%, more preferably by at least 7%, and most preferably by at least 15%.

The above described experiments were repeated with lupines and ACA3276 instead of ACA3282 as the rhizoligand in rhizo signaling gel matrix 10. Lupines were grown in the same conditions as in the experiments described above. Two weeks after planting the samples were allowed to dry until they showed initial wilting symptoms. Then, the plants were irrigated by capillary rise (as described above). Half of the plants were control samples, and half had rhizo signaling gel matrix 10. ACA3276 at a concentration of 0.005% was used. The changes in water content during three drying cycles are shown in FIG. 16. FIG. 16 shows average water content or θ in the lupine samples irrigated with water (blue, n=5) and ACA3276 (red, n=5) during three drying\wetting cycles. Time zero refers to the first application Again, rhizo signaling gel matrix 10 decreased transpiration. The results of rhizo signaling gel matrix 10 with ACA3276 are similar to those obtained with ACA3282.

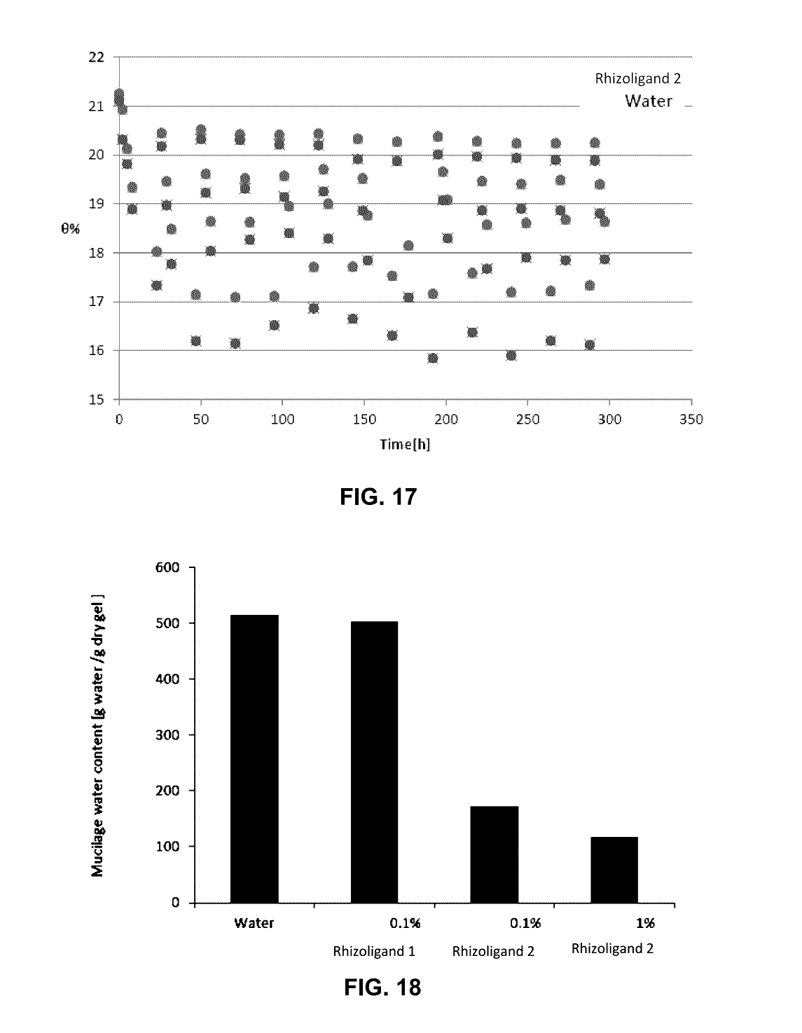

Experiments were again repeated, but the soil kept wet. Every morning at 07:00 water or rhizo signaling gel matrix 10 that was lost by evapotranspiration during the day was replaced. ACA3276 was added at a concentration of 0.005%. In this way, the soil water content varied between 20% and 15%. At the end of the day, the samples with rhizo signaling gel matrix 12 were slightly drier than the control samples, as shown in FIG. 17. FIG. 17 shows average water content or θ in the lupine samples irrigated with water (blue, n=5) and ACA3276 (red, n=5). The samples were irrigated daily. Time zero refers to the first application. This means that the plants irrigated with rhizo signaling gel matrix 10 took up slightly more water. It is believed that when the samples were kept relatively wet, transpiration was not reduced by rhizo signaling gel matrix 10.

Without wishing to be bound by a particular theory, it is believed that suppression of transpiration upon irrigation with rhizo signaling gel matrix 10 was caused by a reduction of the hydraulic conductivity in the rhizosphere. The rhizoligands, which in the experiments were nonionic surfactants (i.e. ACA3282 and ACA3276) affect the maximum swelling rate and viscosity of gels containing hydrophobic components. At specific concentrations, nonionic surfactants decrease the swelling and increase the viscosity of gel containing hydrophobic components.

To test the effect of ACA3282 and ACA3276 on mucigel, mucilage (a type of mucigel) from chia seeds was used. Mucilage from chia seeds has similar physical and chemical properties to that of maize. A maximum swelling of mucilage was measured by immersing a given amount of dry mucilage into 6 ml of water, ACA3282 (0.1%) and ACA3276 (0.1% and 1%). Results are shown in FIG. 18. The mucilage hydrated for 3 days. Then, any amount of water that was not adsorbed into the gel was removed by pouring the gel solution through a sieve of 1 mm. The remaining solution was a gel and its weight was measured. The water content of the gel (wet weight/dry weight) is shown in FIG. 18. Thus, rhizoligands decrease the swelling of mucilage.

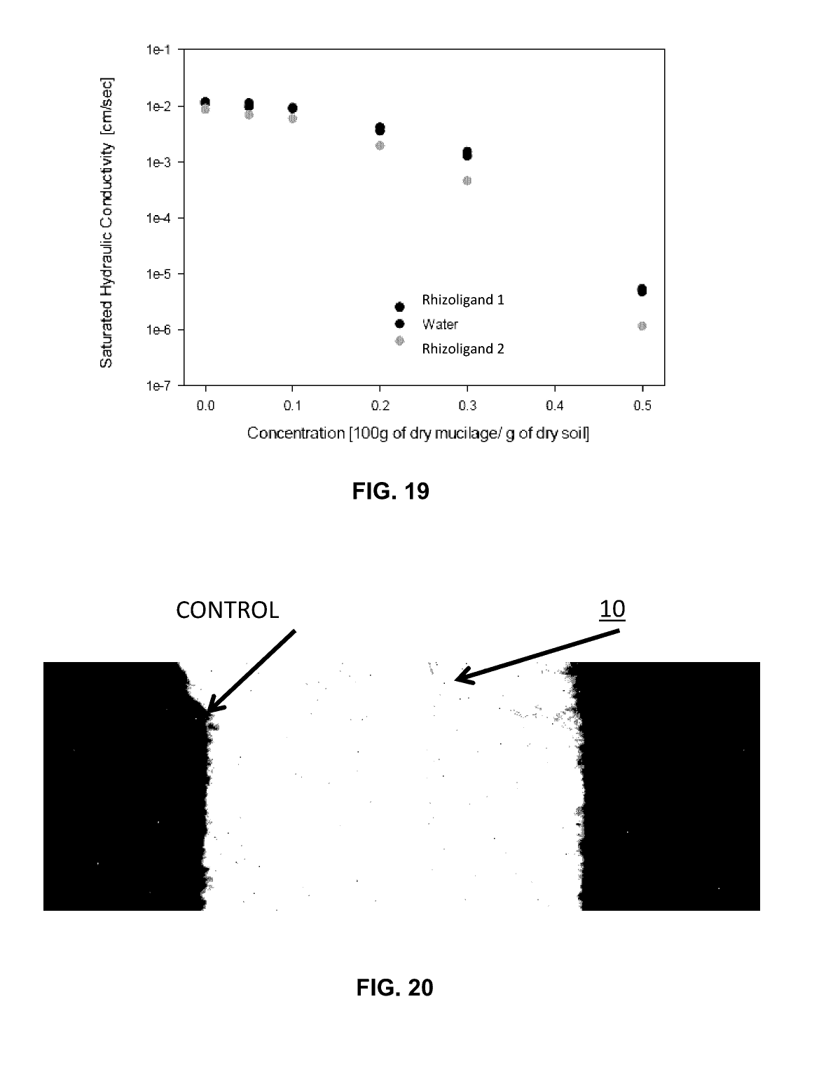

To upscale the effects of the rhizoligand interactions in the rhizosphere, a mixture of mucilage and soil was used. Mucilage was mixed with a sandy soil and then was let dry. Cylinders of 2 cm in diameter were filled with 10 g of dry mucilage-soil mixture and were saturated in water and ACA3276 (0.1%). The saturated hydraulic conductivity of the soil samples was estimated by imposing a constant difference in pressure head between the top and bottom of the sample and measuring the water outflow from the samples. It was found that mucilage decreased the saturated hydraulic conductivity of the soil. See FIG. 19.

Also found was that at high mucilage concentrations, rhizoligands further decreased the soil hydraulic conductivity. It is believed that this reduction in conductivity with surfactants was caused by the lower swelling of mucilage with surfactants and the consequent higher viscosity of the mucilage. The higher mucilage viscosity is expected to limit the diffusion of mucilage away from the rhizosphere. Consequently, it has been found that rhizoligands increase the mucilage concentration near the root surface. This has an additional effect in reducing the hydraulic conductivity of the rhizosphere.

Plant roots employ various mechanisms to increase their access to resources and tolerance to abiotic stress. This includes the production of root hairs, the development of appropriate root system architectures, the fostering of beneficial symbiotic associations and the improvement of physical and biological soil conditions in the rhizosphere.

These phenomena take place in a region known as the rhizosheath, which is operationally defined as the weight of soil that adheres strongly to roots on excavation. Root hairs increase rhizosheath formation. The present disclosure provides that application of rhizo signaling gel matrix 10 increases rhizosheath formation without the need for a plant genome modification approach.

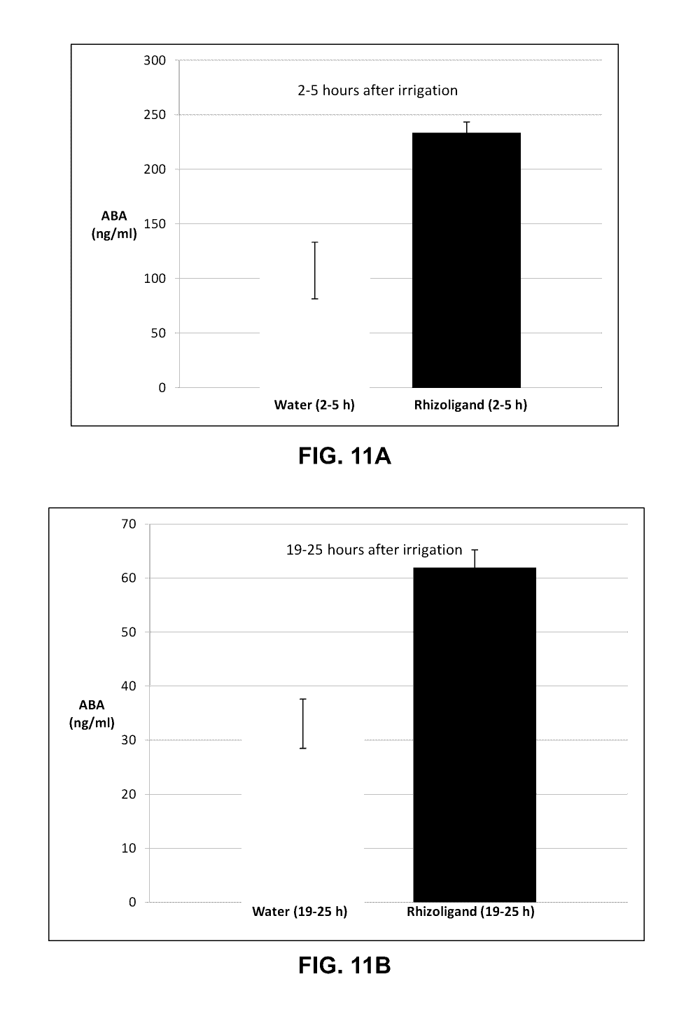

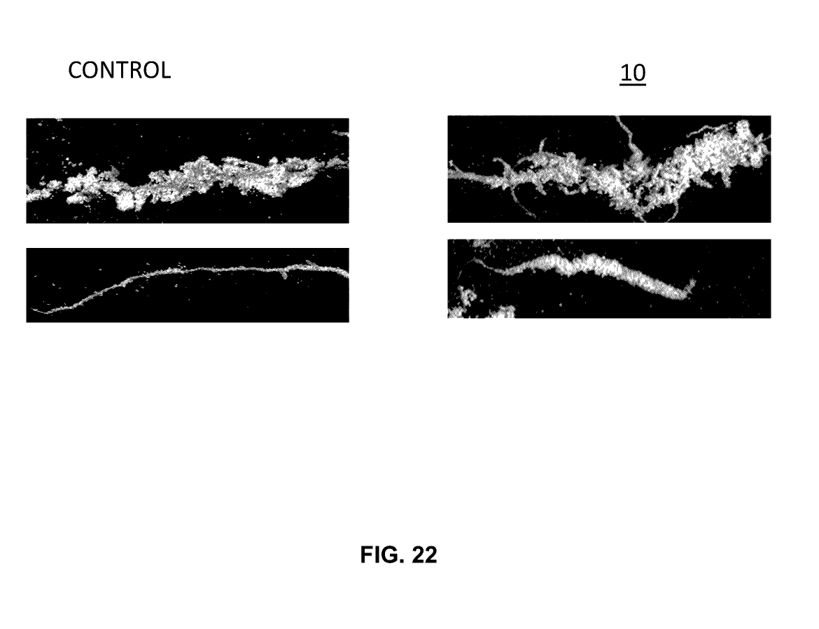

FIGS. 11A and 11B demonstrate the increases in both weight and size of the rhizosheath resulting from use of rhizo signaling gel matrix 10 as compared to a control of water alone. The higher mucilage concentration near the roots results in the stabilization and increase of rhizosheath formation, as shown in FIG. 22. Moreover, it has been found that plants grown using rhizo signaling gel matrix 10 resulted in up to 63% thicker rhizosheaths than plants grown with a control comprising water.

Rhizosheath production is related to many factors, including: root hair length, density, and morphology, root and microbial mucilage, soil water content, soil texture, mycorrhizal fungi, and free living bacteria.

Both root hair length and rhizosheath production have been shown to influence water relations, to alleviate phosphorous (P) and zinc (Zn) deficiencies, and are involved in tolerance to hard soils, water deficit and aluminum (Al) induced acidity tolerance. Rhizosheaths are critical habitats/niches for soil microbes—especially plant growth promoting rhizobacteria. The more developed the rhizosheath is, the more beneficial it is to the bacterial rhizobiome. The bacterial rhizobiome is a population of specialized microorganisms that colonize the plant rhizosphere and endosphere.

Rhizoligands 40 of rhizo signaling gel matrix 10 stabilize the rhizosheaths and create a stable rhizo signaling gel matrix therein. Rhizoligands 40 bind together root exudates and the soil particles and increase the viscosity of the resulting gel, which remains concentrated close to the root, forming a viscous gel that connects the roots to the soil, as discussed above. Rhizoligands 40 increase the effective volume of the rhizosheath which in turn help plants to take up water and nutrients in dry soils.

The rhizoligands 40 in rhizo signaling gel matrix 10 also increase the zone of high soil organic matter and microbial activity

Rhizosheaths having rhizo signaling gel matrix 10 maintain the contact between soil and root and avoids that roots lose contact with the soil when they shrink in response to soil drying. Consequently such rhizosheaths facilitate water and nutrient uptake in dry soils

It has been found that rhizosheaths increase plant tolerance to water stress by limiting the development of air-filled gaps at the root-soil interface during wetting and drying cycles, as discussed above. Contact between soil and root in dry soils, when roots shrink, is maintained. The improved contact facilitates water and nutrient uptake from dry soils. Moreover, it has been found that the rhizosheath keeps the rhizosphere wetter than the bulk soil, making it more conductive to water flow and more diffusive for solutes.

Thus, rhizo signaling gel matrix 10, formed in the rhizosphere, is effective at maintaining optimal biological and biogeochemical processes in the rhizosphere.

Soil quality is also improved by rhizo signaling gel matrix 10 because of the resulting engineered rhizosphere. Effects on soil quality can be chemical, physical, or biological. Chemical effects include nutrient cycling, water relations, and buffering. Physical effects include physical stability and support, water relations, and habitat. Biological effects include biodiversity, nutrient cycling, and filtering.

Organic matter, or more specifically soil carbon, transcends all three soil quality indicator categories and has the most widely recognized influence on soil quality.

Organic matter is tied to all soil functions. It affects other indicators, such as aggregate stability (physical), nutrient retention and availability (chemical), and nutrient cycling (biological), and is itself an indicator of soil quality. Rhizo signaling gel matrix 10 which includes rhizoligand 40, increases soil organic matter.

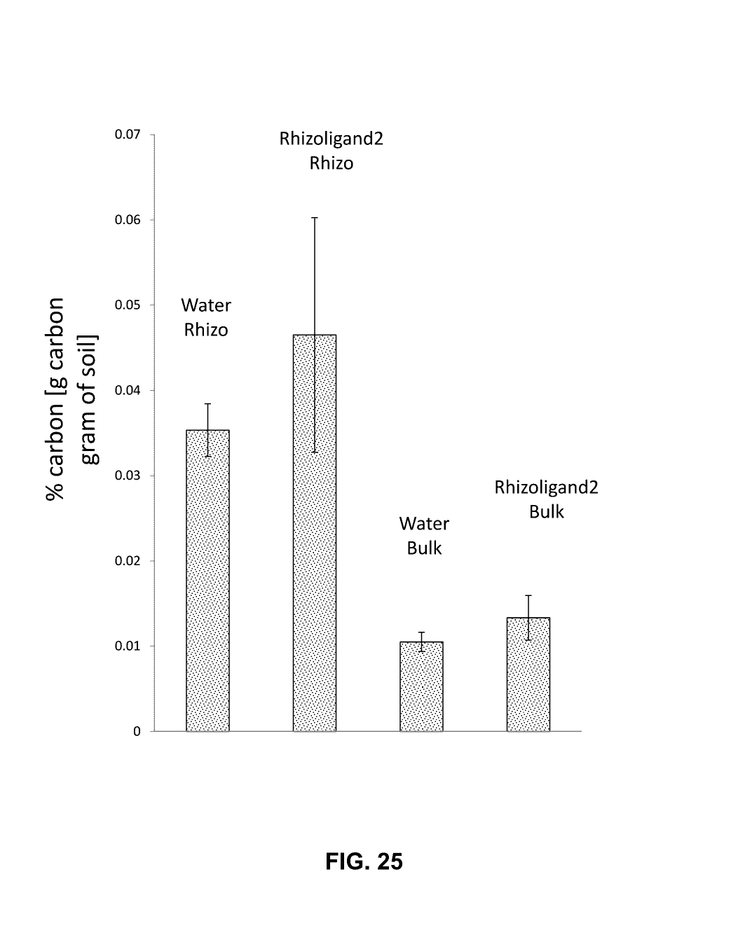

FIG. 25 demonstrates that carbon concentration is even 32.9% higher in the rhizosphere having rhizo signaling gel matrix 10 compared to water alone. It is believed that rhizo signaling gel matrix 10 also is a priming agent for root expansion into the bulk soil.

Carbon concentration is 32.9% higher in the rhizosphere of plants having rhizo signaling gel matrix 10. As discussed above, rhizoligands 40 create a viscous matrix that keeps the root exudates which are a high source of soil organic matter, close to the root surface.

Moreover, the total carbon maintained in the rhizosphere having rhizoligands is even greater, because their rhizosheaths were higher in volume and mass.

Consequences of increased soil organic matter in the rhizo signaling gel matrix according to the present disclosure are critical. Soil organic matter is a source of sugars for soil microbes, provides a hydrated and connected environment for the microbiome, increases stability and maintains nutrients close to the roots (nutrients bound with organic matter), reduces nutrient leaching, promotes root growth and has positive effect on water uptake and nutrient acquisition, and increases longevity of enzymes

Enzymes are a biological indicator of soil quality. Enzyme as a free form in soil solution commonly degrade quickly. However, rhizo signaling gel matrix 10 increases enzyme availability in the rhizosphere.

β-Glucosidase is an enzyme that originates from plants and certain fungi involved in cellulose degradation and releasing of glucose. β-Glucosidase has a direct effect on the stabilization of soil organic matter. β-Glucosidase is an important indicator of the ability of a given soil ecosystem to degrade plant material and provide simple sugars for the microbial population. β-Glucosidase plays an important role in the soil organic carbon cycle.

Sulfatase is an enzyme produced by fungi and bacteria. Sulfatase transforms sulfur contained in organic forms to a form available for plant roots and microorganisms. Sulfatase is significantly correlated with soil organic matter and moisture.

Plants require sulfur for growth, in order to synthesize proteins and build stable photosynthetic complexes. Plants obtain this element from the soil as inorganic sulfate, but are also reliant on other forms of bound soil sulfur, including sulfate esters. However, plants cannot release sulfate esters from the soil themselves, and so they depend on interactions with bacteria that inhabit the rhizosphere. The bacteria, mobilize sulfur for plant uptake.

Bacteria, on the other hand, do not produce more sulfur than they need for themselves, and the sulfatase genes that are responsible for desulfurization of sulfate esters are normally switched off when bacteria are utilizing sulfate. Rhizo signaling gel matrix 10 overcomes this by stimulating the activity of bacterial sulfatases in the rhizosphere and inducing soil bacterial sulfatase gene expression.

In soils of the temperate, humid, and semi-humid regions, sulfur (S) occurs in organic forms, with organic sulfur accounting for >95% of the total sulfur. However, much of the organic sulfur in the soil remains uncharacterized. Organic sulfur generally becomes available to plants through mineralization to sulfate.

Phosphatase mainly originates from plant roots. Phosphatase catalyzes phosphorous containing compounds such as nucleotides and polyphosphates into a form available for root uptake.

Chitinase is an enzyme produced by bacteria and some fungi. Chitinase degrades chitin making carbon and nitrogen available for soil microorganisms and plants. Chitin is the second most abundant polysaccharide in the planet after cellulose. Chitin is a hard and inelastic polysaccharide is found in plants, fungi, yeast, algae, bacteria, insect, some animals. Certain plant disease causing fungi and fungus-like organisms are controlled by chitinolytic bacteria. Chitinases of soil-borne bacteria can decompose chitin of dead fungal hyphae and other resources, but they may also play a role in antagonistic activities against fungi by destroying the chitin in the fungal cell walls. Chitin also functions as a bioshield against plant pathogens and negatively affects soil-inhabiting insect pests.

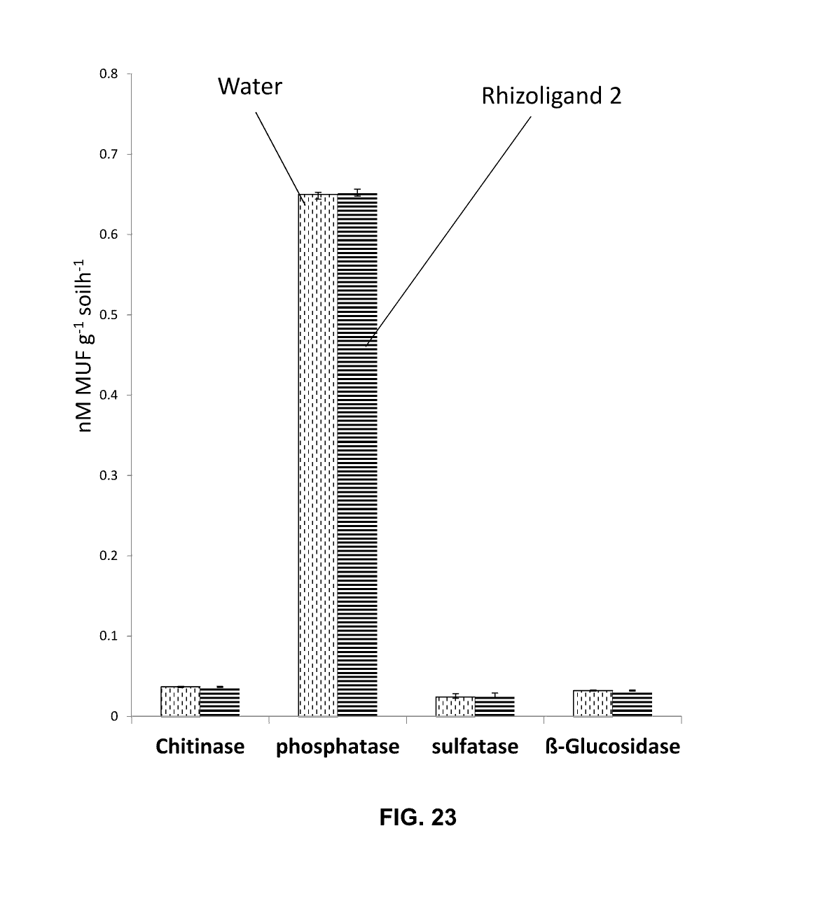

FIG. 23 shows test data comparing enzyme activity in the bulk soil for a rhizosphere with and without the rhizo signaling gel matrix of FIG. 1.

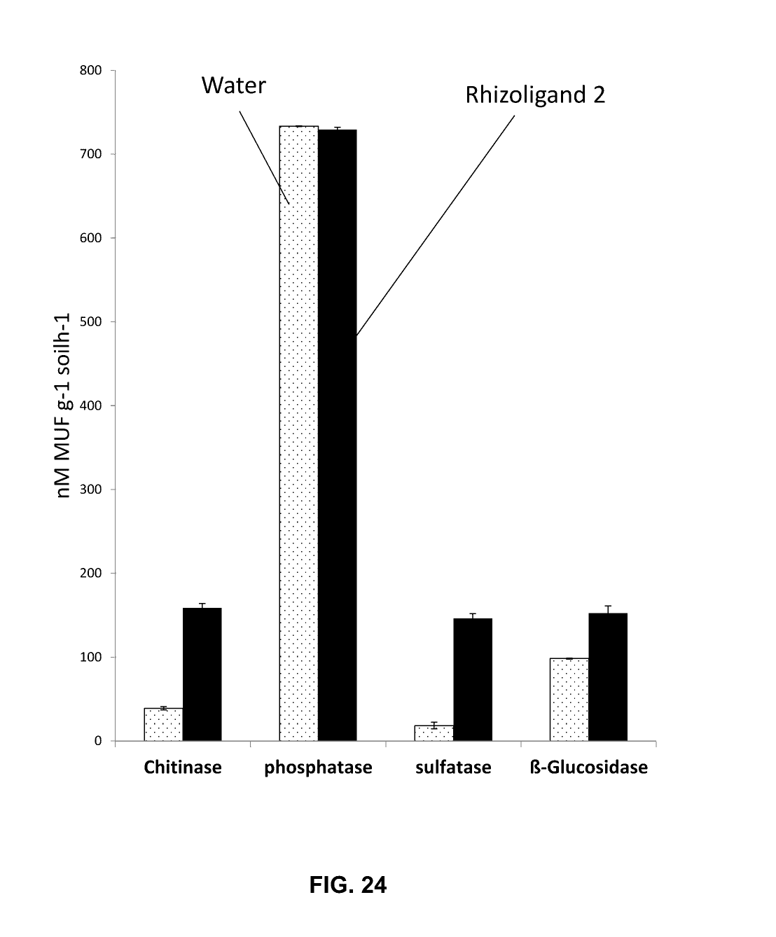

FIG. 24 shows test data comparing enzyme activity in the rhizosphere of lupines for a rhizosphere with and without the rhizo signaling gel matrix of FIG. 1.

Higher chitinase, sulfatase, and β-glucosidase in the rhizosphere containing rhizo signaling gel matrix 10 is explained by the higher soil organic matter and the consequent increase in microbial activity. Although phosphatase is not affected, the reason is that lupines are well known to exude large quantities of phosphatase (in particular by their cluster roots). Therefore it is possible that the potential benefit due to the rhizoligands is not detectable.

Nutrient uptake by plants having rhizo signaling gel matrix 10 in their rhizosphere was measured and is summarized in the tables that follow.

TABLE 1
Nutrient concentration in plants (mg/g)

| Treatments | P | S | Ca | Mg | K |
|---|---|---|---|---|---|
| Water | 13.101 | 15.566 | 9.798 | 3.967 | 66.174 |
| Ligand2 | 16.6 | 17.317 | 10.156 | 4.202 | 69.075 |
| Change | +27% | +11.25% | +6.5% | +5.9% | +4.4% |

TABLE 2
Nutrient element concentration in rhizosphere solution

| | P | S | Ca | Mg | K |
|---|---|---|---|---|---|
| Treatments | mg/g | mg/g | mg/g | mg/g | mg/g |
| Water | 0.13 | 0.24 | 0.11 | 0.04 | 0.87 |
| Ligand2 | 0.11 | 0.18 | 0.08 | 0.03 | 0.85 |
| | (18%) | (33%) | (37%) | (33%) | (2%) |

TABLE 3
Nutrient element concentration in rhizosphere solution

| | B | Cu | Fe | Mn | Mo | Zn |
|---|---|---|---|---|---|---|
| Treatments | μg/g | μg/g | μg/g | μg/g | μg/g | μg/g |
| Water | 1.43 | 0.73 | 2.96 | 0.36 | 0.39 | 1.62 |
| Ligand2 | 0.91 | 0.53 | 2.50 | 0.29 | 0.34 | 1.54 |
| | (57%) | (38%) | (18%) | (24%) | (13%) | (5%) |

The observed increased B-glucosidase resulting from rhizo signaling gel matrix 10 indicates improved soil health.

The observed increased sulfatase resulting from rhizo signaling gel matrix 10 indicates better soil health as a consequence of enhanced soil microbial populations of beneficial bacteria, plant growth promoting rhizobacteria.

The observed increased chitinase resulting from rhizo signaling gel matrix 10 indicates increased plant growth promoting rhizobacteria populations enhancing “bioshield” protection suppressing plant pathogens and insect pests

The observed increased sulfatase and chitinase resulting from rhizo signaling gel matrix 10 are a result of an enhanced rhizobiome.

Among the several realized benefits and advantages of the present disclosure and rhizo signaling gel matrix 10 are enhanced nutrient uptake by plants. The ability of plant roots to take up nutrients from soils is affected by availability of nutrients in soil and transport of nutrients from soil to the root surface. Rhizo signaling gel matrix 10 affects both factors significantly. Specifically, rhizoligand 40 increases microbial activity, resulting in the production of enzymes which transform nutrients into plant available form. Rhizoligand 40 increases the concentration of root exudates and soil organic matter in the rhizosphere, increasing the cation exchange capacity and the adsorption of nutrients in the rhizosphere. These nutrients can be exchanged by organic acids released by the roots. Rhizoligand 40 maintains the rhizosphere hydrated and diffusive for a longer period of time than water alone. Rhizoligand 40 stabilizes the rhizo signaling gel matrix and maintain the connection between the root and soil.

Rhizoligand 40 results in a rhizo signaling gel matrix that is more viscous, remains wettable, swells less, is less diffusive, and stays closely appressed to the root. The consequences are higher ABA transport and production, lower transpiration after drying events, larger, more stable, and longer wettable rhizosheaths, higher soil organic matter in the rhizosphere, higher enzyme activity in the rhizosphere, higher nutrient uptake in the rhizosphere, increased functionality and duration of root transport, and enhanced plant performance under abiotic stress conditions.

The higher viscosity and cation exchange capacity of the rhizosphere with rhizo signaling gel matrix 10, in part due to the interconnected linkages created by the rhizoligands, reduces the leaching of elements far from the rhizosphere. A stable rhizo signaling gel matrix will increase the retention of inorganic and organic compounds, including pesticides (insecticides, fungicides, miticides, nematicides, algaecides), plant growth regulators (including herbicides), and biostimulants.

Rhizo signaling gel matrix 10 can also be formulated to include pesticides, fertilizers, biostiumulants, bio-pesticidal bacteria and the like.

Rhizo signaling gel matrix 10 can also be formulated to also include bio organisms such as nitrogen fixing bacteria, fungi such as mycorrhizal fungi, phytohormones, and plant growth promoting rhizobacteria (naturally occurring or artificially introduced).

The plant growth promoting rhizobacteria (PGPR) should be proficient to colonize the root surface, survive, multiply and compete with other microbiota, and promote plant growth. Examples include Agrobacterium radiobacter, Azospirillum brasilense, Azospirillum lipoferum, Azotobacter chroococcum, Bacillus fimus, Bacillus licheniformis, Bacillus megaterium, Bacillus mucilaginous, Bacillus pumilus, Bacillus spp., Bacillus subtilis, Bacillus subtilis var. amyloliquefaciens, Burkholderia cepacia, Delfitia acidovorans, Paenobacillus macerans, Pantoea agglomerans, Pseudomonas aureofaciens, Pseudomonas chlororaphis, Pseudomonas fluorescens, Pseudomonas solanacearum, Pseudomonas spp., Pseudomonas syringae, Serratia entomophilia, Streptomyces griseoviridis, Streptomyces spp., Streptomyces lydicus and various Rhizobia spp.

Rhizo signaling gel matrix 10 can also be formulated to also include amino acids such as α-Alanine, β-alanine, asparagines, aspartate, cystein, cystine, glutamate, glycine, isoleucine, leucine, lysine, methionine, serine, threonine, proline, valine, tryptophan, ornithine, histidine, arginine, homoserine, phenylalanine, γ-Aminobutyric acid, and α-Aminoadipic acid; organic acids such as citric acid, oxalic acid, malic acid, fumaric acid, succinic acid, acetic acid, butyric acid, valeric acid, glycolic acid, piscidic acid, formic acid, aconitic acid, lactic acid, pyruvic acid, glutaric acid, malonic acid, tetronic acid, aldonic acid, and erythronic acid; sugars such as glucose, fructose, galactose, ribose, xylose, rhamnose, arabinose, desoxyribose, oligosaccharides, raffinose, and maltose; vitamins such as biotin, thiamin, pantothenate, riboflavin, and niacin; purines/nucleosides such as denine, guanine, cytidine, and uridine; and enzymes such as acid/alkaline-phosphatase, invertase, amylase, and protease.

A robust plant is one with a stable, hydrated rhizosphere, that allows the plant to remain healthy under water and nutrient stress—i.e. when the soil resources (water and nutrients) are scarce.

A stable, hydrated rhizosphere is obtained by rhizo signaling gel matrix 10 which has rhizoligands that interact with root exudates to form a viscous, stable and hydrated gel, which maintains root exudates and nutrients close to the root surface. The obtained rhizo signaling gel matrix enhances, soil organic matter, enzyme activity, and nutrient absorption. It also enhances soil microbes, important for mineralization (sulfur) and suppression of phytopathogens (chitinase) in the rhizosphere.

The rapid rewetting of the rhizosphere after drying obtained with rhizo signaling gel matrix 10 results in a pulse of ABA transported from the roots to the shoot, where it temporarily reduces stomata opening and transpiration. This results in a water saving strategy.

Rhizo signaling gel matrix 10 can be applied directly to a plant root. Rhizo signaling gel matrix 10 can alternatively be applied to the rhizosphere, or formulated therein.

It should be noted that where a numerical range is provided herein, unless otherwise explicitly stated, the range is intended to include any and all numerical ranges or points within the provided numerical range and including the endpoints.

It should also be noted that the terms first, second, third, upper, lower, and the like may be used herein to modify various elements. These modifiers do not imply a spatial, sequential, or hierarchical order to the modified elements unless specifically stated.

Although described herein with reference to one or more exemplary embodiments, it will be understood by those skilled in the art that various changes may be made and equivalents may be substituted for elements thereof without departing from the scope of the present disclosure. In addition, many modifications may be made to adapt a particular situation, construction, operation, or material to the teachings of the disclosure without departing from the scope thereof. Therefore, it is intended that the present disclosure not be limited to the particular embodiment(s) disclosed as the best mode contemplated, but that the disclosure will include all embodiments falling within the spirit and scope of the appended claims.

What is claimed is:

1. A rhizo signaling gel matrix comprising:
mucigel;
soil particles; and
a rhizoligand,
wherein the rhizoligand is present in an amount of about 1 μg/kg to about 1 g/kg of soil that is in a rhizosphere of a plant.

2. The rhizo signaling gel matrix of claim 1, wherein the rhizoligand is at least one rhizoligand selected from the group consisting of: bio-surfactant producing bacteria, alkyl terminated block copolymers, alkylpolyglycoside, ethylene oxide, propylene oxide, polymers based on ethylene oxide, polymers based on propylene oxide, ethylene oxide/propylene oxide block copolymers, ethoxylated aliphatic alcohol, carboxylic esters, polyethylene glycol esters, anhydrosorbitol ester and ethoxylated derivatives thereof, glycol esters of fatty acids, carboxylic amides, monoalkanolamine condensates, and polyoxyethylene fatty acid amides.

3. The rhizo signaling gel matrix of claim 1, further comprising a bacterium that excretes a rhizoligand.

4. The rhizo signaling gel matrix of claim 1, wherein the rhizoligand forms an interconnected network of linkages between the soil particles and an interface of a plant root.

5. The rhizo signaling gel matrix of claim 1, wherein the rhizoligand has a rewetting rate in a rhizosphere of at most about 10 minutes.

6. The rhizo signaling gel matrix of claim 1, wherein the rhizoligand causes a maximum swelling of the mucigel of about 0 to about 1000 grams of wet gel per gram of dry gel.

7. The rhizo signaling gel matrix of claim 1, wherein the soil particles are wettable.

8. The rhizo signaling gel matrix of claim 1, wherein the soil particles are non-wettable.

9. The rhizo signaling gel matrix of claim 1, wherein the rhizo signaling gel matrix further comprises at least one bio organism selected from the group consisting of: nitrogen fixing bacteria, fungi, phytohormones, and plant growth promoting rhizobacteria.

10. The rhizo signaling gel matrix of claim 1, wherein the rhizo signaling gel matrix signals a trigger for a pulse of ABA production in the plant that is transported from a root to a shoot.

11. An system comprising:
a plant root;
mucigel;
a rhizomicrobiome;
soil; and
a rhizoligand,
wherein the mucigel, soil, and rhizoligand comprise a rhizo signaling gel matrix wherein the rhizoligand is present at between about 1 μ/kg to about 1 g/kg,
and wherein the rhizo signaling gel matrix is located in a rhizoshphere at an interface with the plant root,
wherein the rhizomicrobiome produces enzymes and hormones in response to the rhizo signaling gel matrix.

12. The system of claim 11, wherein the rhizo signaling gel matrix is appressed to the plant root.

13. The system of claim 11, wherein the rhizo signaling gel matrix forms an interconnected network of linkages between the plant root and soil particles.

14. The system of claim 11, wherein the rhizoligand is at least one rhizoligand selected from the group consisting of: bio-surfactant producing bacteria, alkyl terminated block copolymers, alkylpolyglycoside, ethylene oxide, propylene oxide, polymers based on ethylene oxide, polymers based on propylene oxide, ethylene oxide/propylene oxide block copolymers, ethoxylated aliphatic alcohol, carboxylic esters, polyethylene glycol esters, anhydrosorbitol ester and ethoxylated derivatives thereof, glycol esters of fatty acids, carboxylic amides, monoalkanolamine condensates, and polyoxyethylene fatty acid amides.

15. The system of claim 11, wherein the rhizo signaling gel matrix signals a trigger for a pulse of ABA production in the plant that is transported from the roots to a shoot.

16. The system of claim 11, wherein the rhizoligand causes a change in a water gradient of the soil to trigger a biochemical response.

17. The system of claim 11, wherein the rhizoligand has a rewetting rate in a rhizosphere of about 1 minute to about 10 minutes.

18. The system of claim 11, wherein the rhizoligand causes a maximum swelling of the mucigel of about 0 to about 1000 grams of wet gel per gram of dry gel.

19. A method comprising:
admixing a rhizoligand with a mixture of soil particles and mucigel, thus yielding a rhizo signaling gel matrix, wherein the rhizoligand is present at a concentration of about 1 μ/kg to about 1 g/kg, and wherein the rhizoligand is at least one rhizoligand selected from the group consisting of: bio-surfactant producing bacteria, alkyl terminated block copolymers, alkylpolyglycoside, ethylene oxide, propylene oxide, polymers based on ethylene oxide, polymers based on propylene oxide, ethylene oxide/propylene oxide block copolymers, ethoxylated aliphatic alcohol, carboxylic esters, polyethylene glycol esters, anhydrosorbitol ester and ethoxylated derivatives thereof, glycol esters of fatty acids, carboxylic amides, monoalkanolamine condensates, and polyoxyethylene fatty acid amides; and
contacting a plant's rhizosphere with the rhizo signaling gel matrix.

20. The method of claim 19, wherein the rhizo signaling gel matrix forms an interconnected network of linkages between a plant root and the soil particles.
